(19) United States
(12) Patent Application Publication
(10) Pub. No.: US 2023/0289899 A1
(43) Pub. Date: Sep. 14, 2023

(54) APPARATUS AND METHOD OF DISPLAYING CONTENT BASED ON BLOCKCHAIN

(71) Applicant: Dunamu Inc., Seoul (KR)

(72) Inventors: Jihoon LIM, Seoul (KR); Sejeong SONG, Seoul (KR); Eunyoung KIM, Seoul (KR); Gayoung PARK, Gyeonggi-do (KR); Taeyoung NAM, Seoul (KR); Sojeong LIM, Seoul (KR)

(73) Assignee: Dunamu Inc., Seoul (KR)

(21) Appl. No.: 18/179,688

(22) Filed: Mar. 7, 2023

(30) Foreign Application Priority Data
Mar. 8, 2022 (KR) 10-2022-0029302
Jul. 29, 2022 (KR) 10-2022-0095024
Sep. 7, 2022 (KR) 10-2022-0113376

(51) Int. Cl. G06Q 50/00; G06F 3/14

(52) U.S. Cl. CPC G06Q 50/01; G06F 3/14

(57) ABSTRACT

Provided is an electronic apparatus including a communication interface configured to communicate with one or more nodes of a blockchain network and a first external device, one or more memories configured to store instructions, and one or more processors configured to execute the one or more instructions to generate display information for a contents display area based on token information of tokens registered to respectively correspond to a plurality of unit areas included in the contents display area, and transmit, via the communication interface, the display information to the first external device. The display information indicates at least one image to be displayed in the contents display area displayed on the first external device. The transmitting of the display information causes the first external device to display the display information in the contents display area on the first external device.

### CROSS-REFERENCE TO RELATED APPLICATIONS

This application claims benefit of priority under 35 U.S.C. § 119 to Korean Patent Application No. 10-2022-0029302, filed on Mar. 8, 2022, Korean Patent Application No. 10-2022-0095024, filed on Jul. 29, 2022, and Korean Patent Application No. 10-2022-0113376, filed on Sep. 7, 2022, in the Korean Intellectual Property Office, the disclosures of which are incorporated by reference herein in their entireties.

### BACKGROUND

### 1. Field

The present disclosure relates generally to displaying contents, and more particularly, to apparatuses and methods for displaying contents based on blockchains.

### 2. Description of Related Art

Recently, as various media have appeared, not only idols and actors, but also various types of entertainers or celebrities, such as influencers and YouTubers, are emerging. In the entertainment business related to such entertainers or celebrities, fans who like a specific entertainer are increasingly recording their favorite entertainer's schedule and/or promoting the entertainer to others.

For example, fans are increasingly promoting their favorite entertainer to others by posting the entertainer's photos directly in areas (e.g., advertisement panels or outdoor billboards at subway platforms or bus stops) exposed to an unspecified large number of people. In addition to billboards and bulletin boards with high publicity effects, the cases in which each entertainer's fans secure seats through competitive bidding are also increasing.

### SUMMARY

Embodiments of the present disclosure provide a contents display technique capable of generating an area for displaying contents based on a user's input or selection.

Embodiments of the present disclosure provide a technique for fairly processing token registration requested from a plurality of users.

Embodiments of the present disclosure provide a technique for allowing a user to easily grasp a fandom of a specific object associated with each registered token.

Embodiments of the present disclosure provide a technique for allowing a user of one user terminal to easily acquire notification information for lock-up release of a specific token registered by a user of another user terminal.

According to an aspect of the present disclosure, an electronic device is provided. The electronic apparatus includes a communication interface configured to communicate with one or more nodes of a blockchain network and a first external device, one or more memories configured to store one or more instructions, and one or more processors configured to execute the one or more instructions. The one or more processors are configured to execute the one or more instructions to generate display information for a contents display area based on token information of tokens registered to respectively correspond to a plurality of unit areas included in the contents display area. The one or more processors are further configured to execute the one or more instructions to transmit, via the communication interface, the display information to the first external device. The display information indicates at least one image to be displayed in the contents display area displayed on the first external device. The transmitting of the display information to the first external device causes the first external device to display the display information in the contents display area on the first external device.

In some embodiments, the one or more processors may be further configured to execute the one or more instructions to generate the first information indicating images to be displayed in each of the plurality of unit areas based on the token information and the location information indicating a location of each of the plurality of unit areas in the contents display area. The one or more processors may be further configured to execute the one or more instructions to generate the display information including the first information.

In some embodiments, the contents display area may include one or more daily areas respectively corresponding to one or more dates, and each of the one or more daily areas may include one or more unit areas of the plurality of unit areas. The location information may include information indicating a daily area to which each of the plurality of unit areas belongs.

In some embodiments, the location information may include information indicating coordinate positioning information of each of the plurality of unit areas in the contents display area.

In some embodiments, the one or more processors may be further configured to execute the one or more instructions to determine whether adjacent unit areas among the plurality of unit areas satisfy a preset merging condition, based on the token information and the location information. The one or more processors may be further configured to execute the one or more instructions to, based on a determination that the adjacent unit areas satisfy the preset merging condition, generate second information indicating that an image is to be displayed in an indicated unit area of the adjacent unit areas. The one or more processors may be further configured to execute the one or more instructions to generate the display information including the second information.

In some embodiments, the preset merging condition may be satisfied when adjacent tokens registered to respectively correspond to the adjacent unit areas are associated with a same image.

In some embodiments, the indicated unit area may include at least one of a first rectangular arrangement area having a first size equal to or greater than a predetermined size and a second rectangular arrangement area having a largest size among the adjacent unit areas.

In some embodiments, the preset merging condition may be satisfied when adjacent tokens registered to respectively correspond to the adjacent unit areas are associated with a same image and the adjacent unit areas belong to a same daily area of the contents display area.

In some embodiments, the preset merging condition may be satisfied when adjacent tokens registered to respectively correspond to the adjacent unit areas are associated with a same image and the adjacent unit areas belong to a plurality of adjacent daily areas of the contents display area.

In some embodiments, the one or more processors may be further configured to execute the one or more instructions to determine whether a ratio of first unit areas associated with a same object to second unit areas belonging to one daily area in the contents display area is equal to or greater than a threshold ratio, based on the token information and the location information. The one or more processors may be further configured to execute the one or more instructions to, based on a determination that the ratio is equal to or greater than the threshold ratio, generate third information indicating that a color corresponding to the same object is to be displayed in the one daily area. The one or more processors may be further configured to execute the one or more instructions to generate the display information including the third information.

In some embodiments, the one or more processors may be further configured to execute the one or more instructions to determine whether a ratio of first unit areas associated with a same object to second unit areas belonging to one daily area in the contents display area is equal to or greater than a threshold ratio, based on the token information and the location information. The one or more processors may be further configured to execute the one or more instructions to, based on a determination that the ratio is equal to or greater than the threshold ratio, generate fourth information indicating that a symbol image corresponding to the same object is to be displayed in the one daily area. The one or more processors may be further configured to execute the one or more instructions to generate the display information including the fourth information.

In some embodiments, the same object may be selected from at least one of a person, a plurality of persons, and a company.

In some embodiments, the one or more processors may be further configured to execute the one or more instructions to receive, via the communication interface from the first external device, a first registration request for a first token for a first unit area in the contents display area, register the first token to correspond to the first unit area based on the first registration request, and transmit, via the communication interface to the first external device, information indicating registration of the first token to the first unit area. The first registration request may include location information indicating a location of the first unit area in the contents display area.

In some embodiments, the communication interface may be further configured to communicate with a plurality of external devices that includes the first external device. In such embodiments, the one or more processors may be further configured to execute the one or more instructions to receive, via the communication interface from a second external device of the plurality of external devices, a second registration request for a second token for the first unit area, and determine whether to select the first token or the second token to be registered to correspond to the first unit area based on a first timestamp indicating when the first registration request was received and a second timestamp indicating when the second registration request was received.

In some embodiments, the communication interface may be further configured to communicate with a plurality of external devices that includes the first external device. In such embodiments, the one or more processors may be further configured to execute the one or more instructions to receive, via the communication interface from the plurality of external devices during a time period, a plurality of token registration requests for a first unit area in the contents display area, determine a first object having a largest quantity of requests for registration among one or more objects, based on token information of each of the plurality of token registration requests, determine a first event having a largest quantity of requests for registration among one or more events corresponding to the determined first object, based on token information of each of a plurality of token registration requests associated with the first object, register one or more tokens corresponding to the determined first event to correspond to the first unit area, and transmit, via the communication interface to the plurality of external devices, information indicating registration of the one or more tokens.

In some embodiments, the one or more processors may be further configured to execute the one or more instructions to determine whether the first token satisfies a preset registration condition.

In some embodiments, the one or more processors may be further configured to execute the one or more instructions to prevent changes to the registered first token during a lock-up time duration starting from a registration start time.

In some embodiments, the one or more processors may be further configured to execute the one or more instructions to transmit, via the communication interface to the first external device at a first time point, notification information indicating a lock-up release of the first token at a specific time.

In some embodiments, the first time point may correspond to at least one of a time point at which a lock-up state of the registered first token is released and a time point before the lock-up state of the first token is released.

In some embodiments, the communication interface may be further configured to communicate with a plurality of external devices that includes the first external device. In such embodiments, the one or more processors may be further configured to execute the one or more instructions to receive, via the communication interface from a second external device of the plurality of external devices, a transmission request for notification information for lock-up release of the first token, and transmit, via the communication interface to the second external device at a first time point, the notification information for the lock-up release of the first token. The transmission request for the notification information for the lock-up release may include identifying information identifying the first token and the location information indicating the location of the first unit area registered to correspond to the first token in the contents display area.

According to an aspect of the present disclosure, a method to be performed by an electronic apparatus including one or more processors. The method includes generating, by one or more processors of the electronic apparatus, display information for a contents display area based on token information of tokens registered to respectively correspond to a plurality of unit areas. The method further includes transmitting the display information to an external device. The display information indicates at least one image to be displayed in the contents display area displayed on the external device. The transmitting of the display information to the external device causes the external device to display the display information in the contents display area on the external device.

According to an aspect of the present disclosure, an electronic device is provided. The electronic apparatus includes a communication interface configured to communicate with an external device, one or more memories configured to store one or more instructions, an output unit, and one or more processors configured to execute the one or more instructions. The one or more processors are configured to execute the one or more instructions to receive display information from the external device, and, in response to receiving the display information, output, via the output unit, a contents display area including a plurality of unit areas based on the display information. The display information indicates at least one image to be displayed in the contents display area. The display information has been generated for the contents display area based on token information of tokens registered to respectively correspond to the plurality of unit areas included in the contents display area.

Additional aspects will be set forth in part in the description that follows and, in part, will be apparent from the description, or may be learned by practice of the presented embodiments of the disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view showing a system including a server, a user terminal, a blockchain network, and a communication network, according to one embodiment of the present disclosure;

FIG. 2 is a block diagram of a server, according to one embodiment of the present disclosure;

FIG. 3 is a block diagram of a user terminal, according to one embodiment of the present disclosure;

FIG. 4 is a conceptual diagram of a blockchain network, according to one embodiment of the present disclosure;

FIG. 5 is a flowchart showing an operation of the server that generates display information for a contents display area, according to one embodiment of the present disclosure;

FIG. 6 is an exemplary view showing a contents display area, according to one embodiment of the present disclosure;

FIG. 7 is an exemplary view showing a contents display area, according to another embodiment of the present disclosure;

FIGS. 8A and 8B are exemplary views showing a contents display area when a preset merging condition is satisfied, according to one embodiment of the present disclosure;

FIGS. 9A and 9B are exemplary views showing a contents display area when a preset merging condition is satisfied, according to another embodiment of the present disclosure;

FIGS. 10A and 10B are exemplary views showing a contents display area when a preset merging condition is satisfied, according to another embodiment of the present disclosure;

FIG. 11 is an exemplary view showing a contents display area in which a color corresponding to a specific object is displayed in a specific daily area, according to one embodiment of the present disclosure;

FIG. 12 is an exemplary view showing a contents display area in which a symbol image corresponding to a specific object is displayed in a specific daily area, according to one embodiment of the present disclosure;

FIG. 13 is an exemplary view showing a first screen output through an output unit of a user terminal and including at least one filtering button, according to one embodiment of the present disclosure;

FIGS. 14A and 14B are exemplary views showing a contents display area in which a date display is included or omitted, according to one embodiment of the present disclosure;

FIG. 15 is a flowchart showing an operation of a server that registers a token to correspond to a specific unit area, according to one embodiment of the present disclosure;

FIG. 16A is an exemplary view showing a second screen output through an output unit of a user terminal in a process of registering a token, according to one embodiment of the present disclosure;

FIG. 16B is an exemplary view showing a second screen output through an output unit of a user terminal in a process of registering a token, according to another embodiment of the present disclosure;

FIG. 17 is a flowchart showing an operation of a server that determines, on a first-come, first-served basis, a token to be registered to correspond to a specific unit area, according to one embodiment of the present disclosure;

FIG. 18 is a flowchart showing an operation of a server that determines, by a voting method, a token to be registered to correspond to a specific unit area, according to one embodiment of the present disclosure;

FIG. 19 is an exemplary view showing a third screen output through an output unit of a user terminal in a process of registering a token in a voting method, according to one embodiment of the present disclosure;

FIG. 20 is an exemplary view showing a voting status display area output through an output unit of a user terminal in a process of registering a token in a voting method, according to one embodiment of the present disclosure; and

FIG. 21 is a flowchart showing an operation of a server that communicates with a plurality of user terminals and transmits notification information about lock-up release of a specific token, according to one embodiment of the present disclosure.

### DETAILED DESCRIPTION

Various embodiments described in the present disclosure are exemplified for the purpose of clearly explaining the technical ideas of the present disclosure, and are not intended to be limited thereto. The technical ideas of the present disclosure includes various modifications, equivalents, and alternatives of each embodiment described in the present disclosure, and embodiments selectively combined from all or part of each embodiment. In addition, the scope of the rights of the technical ideas of the present disclosure is not limited to the various embodiments presented below or specific descriptions thereof.

All technical or scientific terms used herein have meanings that are generally understood by a person having ordinary knowledge in the art to which the present disclosure pertains, unless otherwise specified.

The expressions “include,” “can include,” “provided with,” “may be provided with,” “have,” “may have,” and the like used herein mean that features (for example, functions, operations, components, etc.) to be the objects exist, and do not exclude the existence of other additional features. That is, such expressions should be understood as open-ended terms connoting the possibility of inclusion other embodiments.

A singular expression used herein can include meanings of plurality, unless otherwise mentioned, and the same is applied to a singular expression recited in the claims.

Reference throughout the present disclosure to “one embodiment,” “an embodiment,” or similar language may indicate that a particular feature, structure, or characteristic described in connection with the indicated embodiment is included in at least one embodiment of the present solution. Thus, the phrases “in one embodiment”, “in an embodiment,” and similar language throughout this disclosure may, but do not necessarily, all refer to the same embodiment.

The terms “first,” “second,” etc. used herein are used to identify a plurality of components from one another, unless otherwise mentioned, and are not intended to limit the order or importance of the relevant components. For example, each user included in a plurality of users according to the present disclosure may be distinguished from each other by being expressed as, for example, a “first user” and a “second user.” In addition, a plurality of tokens according to the present disclosure may be distinguished from each other by being expressed as, for example, a “first token” and a “second token.”

The expressions “A, B, and C,” “A, B, or C,” “at least one of A, B, and C,” or “at least one of A, B, or C” used herein may mean each of listed items or all possible combinations of listed items. For example, “at least one of A or B” may refer to all of (1) at least one A, (2) at least one B, and (3) at least one A and at least one B.

The term “unit” used herein may mean a software component or hardware component, such as a field-programmable gate array (FPGA) and an application specific integrated circuit (ASIC). However, the “unit” is not limited to software and hardware, and it may be configured to be an addressable storage medium or may be configured to run on one or more processors. In one embodiment, the “unit” may include components, such as software components, object-oriented software components, class components, and task components, as well as processors, functions, attributes, procedures, subroutines, segments of program codes, drivers, firmware, micro-codes, circuits, data, databases, data structures, tables, arrays, and variables.

The expression “based on” used herein is used to describe one or more factors that influence a decision, an action of judgment, or an operation described in a phrase or sentence including the relevant expression, and this expression does not exclude additional factors influencing the decision, the action of judgment, or the operation.

When a certain component (for example, a first component) is described as “coupled to” or “connected to” another component (for example, a second component), this should be understood as meaning that the certain component may be coupled or connected directly to the another component and that the certain component may be coupled or connected to the another component via a new intervening component (for example, a third component).

The expression “configured to” used herein may mean “set to,” “have the ability to,” “changed to,” “made to,” “capable of doing,” etc., depending on the contexts. The expression is not limited in the sense of “specially designed in hardware.” For example, a processor configured to perform a particular operation may mean a generic purpose processor capable of performing that particular operation by executing software, or it may mean a special purpose computer structured through programming to perform the relevant particular operation.

Hereinafter, various embodiments of the present disclosure will be described with reference to the accompanying drawings. Throughout the following description and the accompanying drawings, like or substantially equivalent components are denoted by like reference numerals. In the following description of various embodiments, repeated descriptions of the identical or relevant components will be omitted. However, even if a description of a component is omitted, such a component is not intended to be excluded in an embodiment.

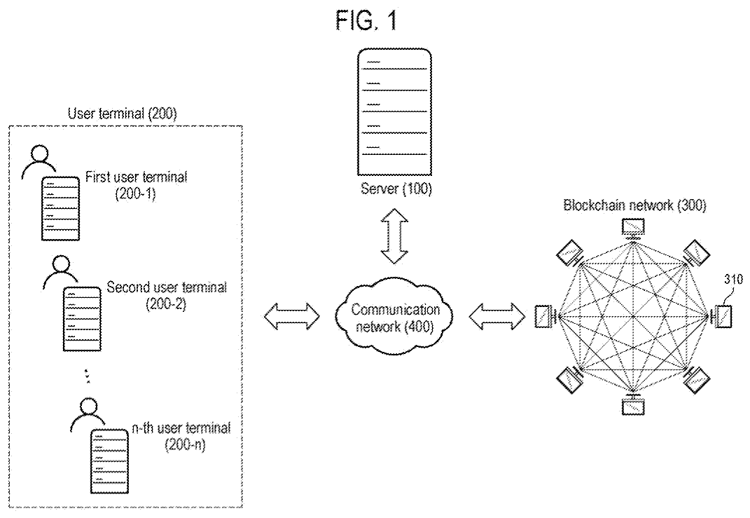

FIG. 1 is a view showing a system including a server 100, a user terminal 200, a blockchain network 300, and a communication network 400, according to one embodiment of the present disclosure. The server 100, the user terminal 200, and at least one blockchain node 310 included in the blockchain network 300 may exchange information with each other through the communication network 400 according to a contents display technique disclosed herein. In the present disclosure, contents may be output (e.g., displayed or expressed) in a relevant device by software or an application running in the server 100, the user terminal 200, or other electronic apparatuses (not shown). The contents disclosed herein may include information and/or data that may be transmitted and/or received between the server 100, the user terminal 200, and other electronic apparatuses, and may be output in at least one of various formats, that include but are not limited to, pictures, photos, videos, texts, colors, and the like. Alternatively or additionally, the contents may be output using formats based-on and/or that include audio output, such as, but not limited to, spoken language, music, sounds, tones, and the like.

The server 100 may be an electronic apparatus of a service provider. The service provider may be an operating entity of a service that provides the contents according to the content display technique disclosed herein. The server 100 may comprise an electronic apparatus that transmits information and/or provides a service to the user terminal 200 connected by wire and/or wirelessly, may be, for example, an application server, a proxy server, a cloud server, or the like. Alternatively or additionally, the server 100 may comprise a processor, a personal computer (PC), a printed circuit board comprising a computing device, a mini-computer, a mainframe computer, a microcomputer, a telephonic computing device, a wired/wireless computing device (e.g., a smartphone, a personal digital assistant (PDA)), or the like. In some embodiments, the server 100 may be a special-purpose computing device configured to perform specific functions according to the content display technique disclosed herein.

In the present disclosure, the user terminal 200 may indicate one user terminal or a plurality of two or more user terminals. For example, when the user terminal 200 indicates a plurality of two or more user terminals 200, the user terminals 200 may be referred to as a first user terminal 200-1, a second user terminal 200-2, . . . , and an n-th user terminal 200-n, respectively, where n is an integer greater than 1.

The user terminal 200 may be a terminal of a user who uses the aforementioned contents providing service provided by the server 100. The user terminal 200 may be at least one of, for example but not limited to, a smartphone, a tablet computer, a PC, a mobile phone, a PDA, an audio player, a wearable device, and the like.

When describing the configuration or operation of a device in the present disclosure, the term “device” may refer to a device that is the object of description, and the term “external device” may refer to a device that exists externally from the viewpoint of the device that is the object of description. For example, when the server 100 is described as a “device,” the user terminal 200 may be referred to as an “external device” from the viewpoint of the server 100. For another example, when the user terminal 200 is described as a “device,” the server 100 may be referred to as an “external device” from the viewpoint of the user terminal 200. That is, the server 100 and the user terminal 200 may be referred to as either a “device” and an “external device,” respectively, depending on the viewpoint of the operating entity.

The blockchain network 300 may refer to at least one blockchain node 310 that manages the blockchain. The at least one blockchain node 310 included in the blockchain network 300 may be an independent electronic device capable of processing calculations required to manage and/or operate the blockchain. At least some operations of the contents display technique disclosed herein may be performed by a smart contract recorded in the blockchain. To this end, the server 100 and/or the user terminal 200 may exchange information with at least one blockchain node 310 included in the blockchain network 300.

The communication network 400 may include a wired communication network and/or a wireless communication network. The communication network 400 may allow data to be exchanged between the server 100, the user terminal 200, and the blockchain network 300. The wired communication network may provide for establishment of connections and/or data transfers between the network elements using one or more communication standards, such as, but not limited to, universal serial bus (USB), high-definition multimedia interface (HDMI), recommended standard-232 (RS-232), plain old telephone service (POTS), Institute of Electrical and Electronics Engineers (IEEE) 802.3 (Ethernet), data over cable service interface specification (DOCSIS), or digital subscriber line (DSL). The wireless communication network may provide for establishment of connections and/or data transfers between the network elements using one or more communication standards, such as, but not limited to, enhanced mobile broadband (eMBB), ultra reliable low-latency communications (URLLC), massive machine type communications (MMTC), long-term evolution (LTE), LTE advance (LTE-A), New Radio (NR), universal mobile telecommunications system (UMTS), global system for mobile communications (GSM), code division multiple access (CDMA), wideband CDMA (WCDMA), wireless broadband (WiBro), Wireless Fidelity (Wi-Fi), Bluetooth, Bluetooth low energy (BLE), near field communication (NFC), global positioning system (GPS), or global navigation satellite system (GNSS). The communication network 400 of the present disclosure is not limited to the above-mentioned examples, and may include, without limitation, various types of communication networks that allow data to be exchanged between a plurality of entities or devices.

FIG. 1 illustrates just one example of a system architecture that may be used, and those of skill in the art will appreciate that the specific system architecture used may vary, and are secondary to the functionality that they provide, as further described herein. For example, a particular server 100 may comprise a single physical machine or may comprise a combination of multiple virtual machines.

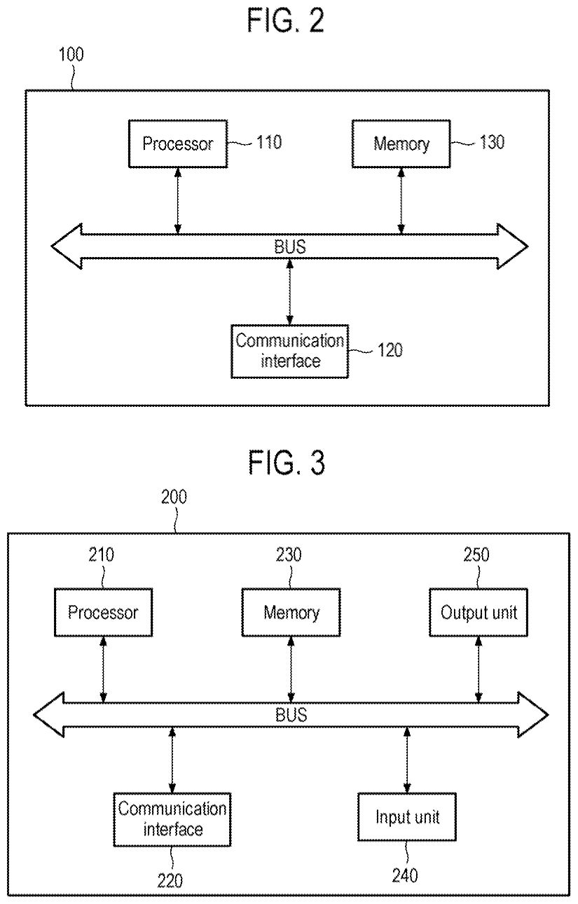

FIG. 2 is a block diagram of the server 100 according to one embodiment of the present disclosure. The server 100 may include, as components, one or more processors 110, a communication interface 120, and a memory 130. In some embodiments, at least one of these components of the server 100 may be omitted, or other components may be added to the server 100. In some embodiments, additionally or alternatively, some components may be integrated, or may be implemented as a singular or a plurality of entities. At least some of the components inside or outside the server 100 may exchange data or signals with each other by being connected to each other through a bus, such as, but not limited to, a general purpose input/output (GPIO) bus, a serial peripheral interface (SPI) bus, or a mobile industry processor interface (MIPI) bus.

One or more processors 110 may be referred to as a processor 110. The term “processor 110” may refer to a set of one or more processors, unless otherwise explicitly indicated in the context. The processor 110 may drive (e.g., execute) software (e.g., instructions, instruction sets, code, code segments, programs, program code, subprograms, software components, applications, software applications, software packages, routines, subroutines, executables, threads of execution procedures, functions, etc., whether referred to as software, firmware, middleware, microcode, hardware description language, or otherwise) to control at least one component of the server 100 connected to the processor 110. Alternatively or additionally, the processor 110 may perform operations such as various calculations, processes, and/or data generation or processing. In some embodiments, the processor 110 may load (e.g., read) data or the like from the memory 130 and/or store (e.g., write) data or the like in the memory 130.

The communication interface 120 may perform wireless or wired communication between the server 100 and another device (e.g., the user terminal 200, the blockchain node 310, another server). The communication interface 120 may transmit and/or receive communications, such as control information, data communications, or a combination thereof, from an external device (e.g., the user terminal 200, the blockchain node 310, another server). For example, the communication interface 120 may perform wireless communication using one or more communication standards, such as, but not limited to, eMBB, URLLC, MMTC, LTE, LTE-A, NR, UMTS, GSM, CDMA, WCDMA, WiBro, Wi-Fi, Bluetooth, BLE, NFC, GPS, or GNSS. For another example, the communication interface 120 may perform wired communication using one or more communication standards, such as, but not limited to, USB, HDMI, RS-232, POTS, Ethernet, DOCSIS, or DSL. In some embodiments, the communication interface 120 may perform signal processing on the received communications and/or provide the received communications and/or the processed signals to one or more other components of the server 100 (e.g., processor 110) Alternatively or additionally, the communication interface 120 may perform signal processing on generated communications from one or more other components of the server 100 (e.g., processor 110) and/or transmit the generated communications and/or the processed signals to the external device. The communication interface 120 may comprise one or more antennas, a controller/processor, a memory, or a combination thereof. The communication interface 120 may be implemented as a transceiver or transceiver component and/or as separate receiving and transmitting components.

The memory 130 may store various types of data. The data stored in the memory 130 may be data acquired, processed, and/or used by at least one component of the server 100, and may include software, non-executable data, content (e.g., audio data, visual data), and the like. The memory 130 may include volatile and/or nonvolatile memory. The term “memory 130” may refer to a set of one or more memories, unless otherwise explicitly indicated in the context. The expression “a set of instructions stored in the memory 130” or “a program stored in the memory 130” may refer to an operating system for controlling the resources of the server 100, an application, middleware that provides various functions to the application so that the application may utilize the resources of the server 100, etc. In one embodiment, when the processor 110 performs a calculation, the memory 130 may store instructions performed by the processor 110 corresponding to the calculation.

In one embodiment, the server 100 may transmit, via the communication interface 120 to an external device, data according to a calculation result of the processor 110, data received by the communication interface 120, data stored in the memory 130, and the like. The external device may be a device configured to output (e.g., display, present, or express) the received data.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally or alternatively, a set of (one or more) components shown in FIG. 2 may perform one or more functions described as being performed by another set of components.

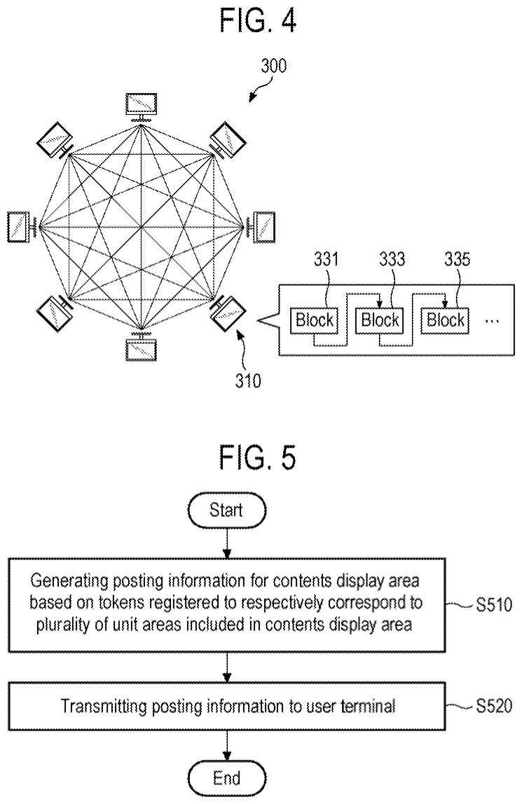

FIG. 3 is a block diagram of the user terminal 200 according to one embodiment of the present disclosure. The user terminal 200 may include, as components, one or more processors 210, a communication interface 220, and a memory 230. In some embodiments, the user terminal 200 may further include at least one of an input unit 240 and an output unit 250.

The processor 210 may drive software (e.g., instructions, programs, etc.) to control at least one component of the user terminal 200 connected to the processor 210. Alternatively or additionally, the processor 210 may perform operations such as various calculations, processes, and/or data generation or processing. In some embodiments, the processor 210 may load (e.g., read) data or the like from the memory 230 and/or store (e.g., write) data or the like in the memory 230.

The communication interface 220 may perform wireless or wired communication between the user terminal 200 and another device (e.g., the server 100, blockchain node 310, another server, another user terminal 200). For example, the communication interface 220 may perform wireless communication using one or more communication standards, such as, but not limited to, eMBB, URLLC, MMTC, LTE, LTE-A, NR, UMTS, GSM, CDMA, WCDMA, WiBro, WiFi, Bluetooth, BLE, NFC, GPS, or GNSS. For another example, the communication interface 220 may perform wired communication using one or more communication standards, such as, but not limited to, USB, HDMI, RS-232, POTS, Ethernet, DOCSIS, or DSL. In some embodiments, the communication interface 220 may perform signal processing on the received communications and/or provide the received communications and/or the processed signals to one or more other components of the user terminal 200 (e.g., processor 210) Alternatively or additionally, the communication interface 220 may perform signal processing on generated communications from one or more other components of the user terminal 200 (e.g., processor 210) and/or transmit the generated communications and/or the processed signals to the external device. The communication interface 220 may comprise one or more antennas, a controller/processor, a memory, or a combination thereof. The communication interface 220 may be implemented as a transceiver or transceiver component and/or as separate receiving and transmitting components.

The memory 230 may store various types of data. The data stored in the memory 230 may be data acquired, processed, and/or used by at least one component of the user terminal 200, and may include software, non-executable data, content (e.g., audio data, visual data), and the like. The memory 230 may include volatile and/or nonvolatile memory. The term “memory 230” may refer to a set of one or more memories, unless otherwise explicitly indicated in the context. The expression “a set of instructions stored in the memory 230” or “a program stored in the memory 230” may refer to an operating system for controlling the resources of the user terminal 200, an application, middleware that provides various functions to the application so that the application may utilize the resources of the user terminal 200, etc. In one embodiment, when the processor 210 performs a calculation, the memory 230 may store instructions performed by the processor 210 corresponding to the calculation.

In one embodiment, the user terminal 200 may further include the input unit 240. The input unit 240 may provide data, which has been received from outside of the user terminal 200, to at least one component included in the user terminal 200. For example, the input unit 240 may include, but not be limited to, a mouse, a keyboard, a touch pad, a track ball, a joystick, a table pen, a pair of virtual reality (VR) gloves, and the like.

In one embodiment, the user terminal 200 may further include the output unit 250. The output unit 250 may display (output) and/or transmit (send out) information processed by the user terminal 200 to outside of the user terminal 200. For example, the output unit 250 may visually display the information processed by the user terminal 200. The output unit 250 may display user interface (UI) information and/or graphical user interface (GUI) information. In this case, the output unit 250 may include at least one of a liquid crystal display (LCD), a thin film transistor-liquid crystal display (TFT-LCD), an organic light-emitting diode (OLED), a flexible display, a three-dimensional (3D) display, an E-ink display, and VR googles. For another example, the output unit 250 may audibly present the information processed by the user terminal 200. The output unit 250 may output audio data conforming to an arbitrary audio file format (e.g., moving picture experts group layer-3 (MP3), free lossless audio codec (FLAC), waveform audio file (WAV), etc.) through an audio device. In this case, the output unit 250 may include at least one of a speaker, a headset, a pair of earbuds, and a headphone. For another example, the output unit 250 may transmit the information processed by the user terminal 200 to an external output device. The output unit 250 may transmit and/or send out the information processed by the user terminal 200 to the external output device by using the communication interface 220. In some embodiments, the output unit 250 may transmit and/or send out the information processed by the user terminal 200 to the external output device by using a separate output communication interface (not shown).

The number and arrangement of components shown in FIG. 3 are provided as an example. In practice, there may be additional components, fewer components, different components, or differently arranged components than those shown in FIG. 3. Furthermore, two or more components shown in FIG. 3 may be implemented within a single component, or a single component shown in FIG. 3 may be implemented as multiple, distributed components. Additionally or alternatively, a set of (one or more) components shown in FIG. 3 may perform one or more functions described as being performed by another set of components.

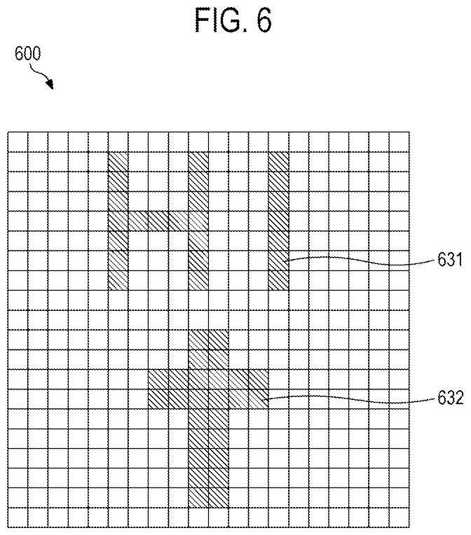

FIG. 4 is a conceptual diagram of the blockchain network 300 according to one embodiment of the present disclosure. In the present disclosure, a block may refer to a specific data type. In addition, a blockchain may refer to a data structure in which one or more blocks (e.g., first block 331, second block 333, and third block 335) are connected in a chain form. The one or more blocks (e.g., first block 331, second block 333, and third block 335) included in the blockchain may be stored independently in one or more nodes included in the blockchain network 300 (e.g., blockchain node 310), and/or may be distributed and stored across multiple nodes. Each of the one or more blocks (e.g., first block 331, second block 333, and third block 335) may include a block hash, a block header, and/or a block body (not shown). The block hash may comprise unique information that may identify a block, and may be implemented as, for example, a character string expressed in 256 bits. The block header may include at least one of, for example, version information of software or protocol, a block hash of the previous block according to the connection order of blocks on the blockchain, a Merkle root, time information indicating when the block was created, bits representing a difficulty of calculation, and Nonce, which is a value required for mining operations that add new blocks to the blockchain. The block body may include at least one transaction. A transaction may refer to a set of data having a specific data structure, and may be a unit of information stored in the block body. The transaction data may include information about the creation of a token and/or a transaction of a token. The transaction may comprise, for example, information of the content “a first node included in the blockchain network 300 transmits a virtual currency token to a second node.” As another example, the transaction may be information of the content “a first node included in the blockchain network 300 transmits a non-fungible token (NFT) to a second node.”

The blockchain may be managed by the blockchain network 300 including at least one blockchain node 310. Each node included in the blockchain network 300 may be referred to as a “participant” of the blockchain network 300. The at least one blockchain node 310 included in the blockchain network 300 may be operated by a hierarchical structure. The hierarchical structure may include at least one of, for example, a data layer that defines the structure of data handled by the blockchain network 300 and manages the data, a consensus layer that performs mining to verify the validity of a block and generate the block and is responsible for processing fees paid to a miner in the mining process, a common layer that implements or manages a peer-to-peer (P2P) network protocol, a hash function, a digital signature, encoding, and a common repository, and an application layer where various applications are created and/or processed.

The at least one blockchain node 310 included in the blockchain network 300 may share and/or store the transaction recorded on the blockchain. Alternatively or additionally, the at least one blockchain node 310 included in the blockchain network 300 may perform a function of performing a verification operation on the transaction transmitted to the blockchain network 300 through a consensus algorithm of the blockchain and, when the verification is completed, recording the verified transaction in one block on the blockchain. The consensus algorithm performed by the blockchain network 300 may include, but not be limited to, at least one of a Proof of Work (PoW) algorithm, a Proof of Stake (PoS) algorithm, a delegated Proof of Stage (DPoS) (algorithm, a Practical Byzantine Fault Tolerance (PBFT) algorithm, a Delegated Byzantine Fault Tolerance (DBFT) algorithm, a Redundant Byzantine Fault Tolerance (RBFT) algorithm, a Sieve algorithm, a Tendermint algorithm, a Paxos algorithm, a Raft algorithm, a Proof of Authority (PoA) algorithm, and a Proof of Elapsed Time (PoET)algorithm.

Each node included in the blockchain network 300 may store a smart contract. Through this, the nodes included in the blockchain network 300 may share the same smart contract. Alternatively or additionally, the smart contract may be recorded in one block on the blockchain managed by the blockchain network 300. The smart contract may, for example, be a document and/or script written in a programming language, such as, but not limited to, Solidity, and may be a program and/or application running on a virtual machine that is executed by at least one blockchain node 310 included in the blockchain network 300. The smart contract may be written so that a specific action is executed when a specific condition is satisfied. In this case, the specific condition may be, for example, a condition in which a specific type of token is input or a specific type of file is input. Alternatively or additionally, the specific action may be, for example, an action such as transmitting a specific type of token to an arbitrary node of the blockchain network 300.

The smart contract may be written to comply with a certain rule (or protocol). For example, the smart contract may be written to include one or more functions corresponding to a protocol of each of Ethereum request for comment 20 (ERC-20) and ERC-721. However, by including other functions (e.g., one or more functions corresponding to ERC-1155) not included in the exemplified protocols, in the smart contract, various types of smart contracts may be written.

The token referred to in the present disclosure may be a token that may be used on the blockchain managed by the blockchain network 300, and may be a virtual currency token (or a fungible token) and/or an NFT. The NFT may refer a virtual token created according to a smart contract written with reference to a certain protocol (e.g., ERC-721, ERC-1155, etc.). This NFT may be recorded on the blockchain, which is a decentralized storage, thereby maintaining the integrity, and this NFT may be created to include specific types of data, thereby guaranteeing the existence of specific types of data. Hereinafter, an object simply referred to as the “token” in the present disclosure may be an NFT, unless otherwise indicated in the context.

Information about the token according to the present disclosure may be a set of data including a plurality of types of data. The information about the token may include at least one of token identification information (hereinafter, also referred to as “token ID”), information indicating a specific object, event identification information (hereinafter, also referred to as “event ID”), an issue number related to an event, information for accessing a digital file connected with a token (hereinafter, also referred to as a “digital file uniform resource identifier (URI)”), information for accessing metadata of the token (hereinafter, also referred to as a “metadata URI”), and information on the current owner of the token (e.g., an address on the blockchain of a node of the current owner of the token). In addition, in the present disclosure, for convenience of description, it is assumed that the token-related information recorded in the blockchain network 300 includes the digital file URI or the metadata URI, but the present disclosure is not limited thereto, and the token-related information recorded in the blockchain network 300 may directly include a digital file connected with the token, or metadata of the token itself.

The “token ID” included in the information about the token may be a value unique to each token and may be a value for distinguishing a plurality of tokens. The token ID may be, for example, a natural number such as “0x123456” or a character string such as “ab3d-efgl-ij21.”

A token according to the present disclosure may be associated with a specific object. The expression “a token is associated with a specific object” may be an expression indicating a relationship between the token and the specific object if a digital file connected with the token is a digital file of the specific object (e.g., a photo or video of the specific object, a picture of the specific object, or music composed by the specific object). The specific object may be, for example, a specific person such as a real person such as an entertainer or a celebrity, or a virtual person such as a character. Alternatively or additionally, the specific object may be a set of persons, for example, a group of singers. For another example, the specific object may be a specific company, for example, the agency representing an actor or a singer. Alternatively or additionally, the specific object may be an animal such as a dog or a cat, which may be real or fictional.

“Information indicating a specific object” included in the information about the token may be, for example, a character string indicating the name or designation of the specific object associated with the corresponding token, such as “John.”

An “event” according to the present disclosure may correspond to a digital file related to a specific object. The “event” and the “digital file related to the specific object” may have a one-to-one data relationship. The digital file related to the specific object may be an image file related to the specific object. In the present disclosure, an “image” may refer to a visual representation that may be displayed on an electronic apparatus. The image may include one or a plurality of still images. Alternatively or additionally, when the image includes a plurality of still images sequentially displayed according to a specific time interval, the image may be referred to as a “video.” Hereinafter, in the present disclosure, an “image related to a specific object corresponding to an event” may be briefly referred to as an “event image” or an “image of an event” for convenience of description. In some embodiments, a plurality of different events may exist for one specific object. For example, when a plurality of images are generated by photographing a singer “A” from different times or different directions, different events may be generated for the respective plurality of generated images. That is, the “specific object” and the “event” may have a one-to-many data relationship.

The “event ID” included in the information about the token may be a value unique to each event and may be a value for distinguishing a plurality of different events. For example, a first event having a first image generated by photographing one specific object at a specific time and in a specific direction and a second event having a second image generated by photographing the specific object at a different time or direction may have different event IDs. The event ID may be, for example, a natural number such as “0x3333” or a character string such as “dd13-15ry-2fev.”

The event according to the present disclosure may correspond to at least one token. That is, the “event” and the “token” may have a one-to-many data relationship. When a specific event corresponds to a plurality of tokens, images of the plurality of tokens may be the same image. When the plurality of tokens correspond to the same specific event, the plurality of tokens may have issue numbers. For example, when there are 1,000 tokens corresponding to a specific event, the 1,000 tokens may have issue numbers ranging from 1 to 1,000. For another example, the 1,000 tokens may be assigned distinct non-consecutive issue numbers.

An “event-related issue number” included in the token-related information may be a number unique to the corresponding token among a plurality of tokens generated to correspond to the specific event. The issue number may be, for example, a natural number such as “200.” Alternatively or additionally, the issue number may be a character string such as “200/1000”, which may indicate a number unique to the corresponding token as well as additionally indicate information on the total number of tokens corresponding to the corresponding event.

In one embodiment, two tokens may be associated with a singer “A” (that is, a token “T1” and a token “T2”), and it may be assumed that both the token “T1” and the token “T2” correspond to the same event having an event ID of “0x1111.” It may also be assumed that the total number of tokens corresponding to a specific event having an event ID of “0x1111” is 1,000. As such, information about the token “T1” may include, for example, information such as {“token ID”: 0xabcd, “associated specific object”: “A”, “event ID”: 0x1111, “issue number”: 1/10001}. Also, information about token “T2” may include, for example, information such as {“token ID”: 0xefgh, “associated specific object”: “A”, “event ID”: 0x1111, “issue number”: 2/10001}.

The “digital file URI” included in the token-related information may be an address of a centralized server or a cloud server where a digital file is stored. Alternatively or additionally, the digital file URI may be a hash value (e.g., “ipfs.io/ipfs/12345678”) of a digital file stored on an interplanetary file system (IPFS) that distributes and stores files in multiple devices. A digital file accessed through the digital file URI may be, for example, an image file, a music file, or the like, which may be a file corresponding to the above-mentioned event. Hereinafter, in the present disclosure, the expression “a digital file connected with a token” may refer to a digital file acquired through the digital file URI recorded in the token, and may be used interchangeably with an expression such as a “digital file of a token” or a “digital file associated with a token.”

The “metadata URI” of the token-related information may be an address of the centralized server or a cloud server where metadata of the token is stored. Alternatively or additionally, the metadata URI may be a hash value of metadata stored on IPFS. The metadata of the token may refer to a data set including various information about the token. The metadata may include at least one of, for example, token name, token ID, the name of a specific object associated with the token, the point of time when the token was created, information about the current owner of the token, history of change to the token owner, even-related information (e.g., an event ID, an issue number, or the like) corresponding to the token, and a digital file URI.

Hereinafter, the expression “token-related information” in the present disclosure may be briefly referred to as “token information” for convenience of description. At least some of various pieces of information included in the token information may be stored in the memory of the server 100 or the user terminal 200. Alternatively or additionally, at least some of the various pieces of information included in the token information may be recorded in a block managed by the blockchain network 300.

A token according to the present disclosure may belong to one or more token groups. Token group information corresponding to the token may include information (e.g., a character string of a token group name) indicating each of one or more token groups to which the token belongs. For example, when a first token is a token created to correspond to person A, the token group information corresponding to the first token may include information indicating a “person A token group.” Alternatively or additionally, when the first token is a token created to correspond to team B, the token group information corresponding to the first token may include information indicating a “team B token group.” Furthermore, when the first token is a token created to correspond to person C, and person C is a person belonging to team D consisting of a plurality of persons, the first token may belong to a “person C token group” and at the same time a “team D token group.” In this case, the token group information corresponding to the first token may include information indicating the “person C token group” and information indicating the “team D token group.” The token group information corresponding to the token may be stored in the memory 130 of the server 100, recorded in one block on the blockchain, or included in the metadata of the token.

A token according to the present disclosure may be managed by a smart contract. In the present disclosure, the expression “a token is managed by a smart contract” may refer to various operations, such as, a token being created by a smart contract, a token being transmitted from one user's address to another user's address, a token being incinerated, etc. The smart contract may contain various kinds of functions.

The smart contract may be created to comply with a certain rule (or protocol). For example, a smart contract written to comply with any first protocol (e.g., ERC-20) may include a function that returns the total supply amount of virtual currency tokens. The smart contract written to comply with the first protocol may include a function that acquires an address on the blockchain of a specific node and returns the amount of virtual currency tokens held by the address. The smart contract written to comply with the first protocol may include a function that acquires an arbitrary amount of virtual currency tokens and an address on the blockchain of a node that receives the virtual currency token, and transmits the virtual currency token to the address of the receiving node. The smart contract written to comply with the first protocol may include a function that acquires an arbitrary amount of virtual currency tokens, an address on the blockchain of a node that sends the virtual currency token, and an address on the blockchain of a node that receives the virtual currency token, and transmits the virtual currency token from the address of the sending node to the address of the receiving node. The smart contract written to comply with the first protocol may include a function that returns whether withdrawal is allowed to limit the amount of withdrawable virtual currency tokens. Alternatively or additionally, the smart contract written to comply with the first protocol may include a function that returns the remaining amount that may be withdrawn.

Alternatively or additionally, a smart contract written to comply with an arbitrary second protocol (e.g., ERC-721) may include a function that generates a token (e.g., NFT) based on one or more pieces of information received from a specific node (hereinafter, also referred to as a “token generation function”). For example, the token generation function may acquire a URI of a specific digital file received from a specific node and an address on the blockchain of an arbitrary node, and generate a token corresponding to the URI of the corresponding digital file. When the token is generated by the token generation function, the owner information of the corresponding token may be determined according to the address on the blockchain of the arbitrary node input to the token generation function. The token generation function may further acquire one or more pieces of information (e.g., a token name, a date attribute group including at least one date attribute regarding the token, etc.) to be included in the token metadata and generate the token. In the present disclosure, the expression “generating an NFT” may be used interchangeably with the expression “minting an NFT.” Alternatively or additionally, the smart contract written to comply with the second protocol may include a function that acquires an address on the blockchain of an arbitrary node and returns the amount of tokens held by the arbitrary address. The smart contract written to comply with the second protocol may include a function that acquires a token ID of an arbitrary token and returns information about the owner who owns the token. The smart contract written to comply with the second protocol may include a function that acquires an address on the blockchain of an arbitrary node and a token ID of the arbitrary token and grants the arbitrary node the authority to transmit a token with the corresponding token ID. The smart contract written to comply with the second protocol may include a function that acquires a token ID of an arbitrary token and returns an address on the blockchain of one or more nodes that have the authority to transmit the corresponding token.

The description of the smart contracts written to comply with the above-described first and second protocols is merely an exemplary description for explaining the functions included in the smart contract, and does not limit the present disclosure. A smart contract according to the present disclosure may include various types of smart contracts including at least one function related to a token.

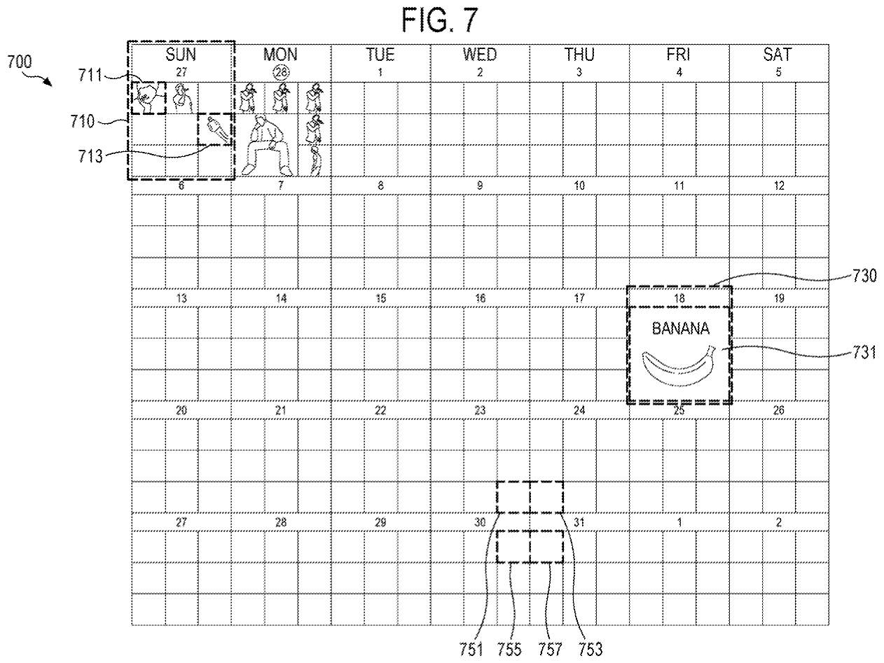

Hereinafter, a process of generating, by the server 100, display information for a contents display area for transmission to the user terminal 200 is described with reference to FIGS. 5 to 7.

FIG. 5 is a flowchart of an operation of the server 100 that generates display information for a contents display area, according to one embodiment of the present disclosure.

The server 100 may generate the display information for the contents display area based on tokens registered to respectively correspond to a plurality of unit areas included in the contents display area (S510). In one embodiment, the processor 110 may generate information indicating an image to be displayed on each of the plurality of unit areas (hereinafter, also referred to as “first information”) based on token information about tokens registered to respectively correspond to the plurality of unit areas and location information indicating a location within a contents display area of each of the plurality of unit areas, and may generate the display information including the generated first information. The server 100 may transmit the generated display information to the user terminal 200 (S520). The user terminal 200 may receive the generated display information from the server, and may output the contents display area through the output unit 250 based on the first information included in the display information.

In the present disclosure, the “contents display area” may be at least one area of a screen output through the output unit 250 of the user terminal 200, and may output an image connected to at least one registered token. The contents display area may be output through the output unit 250 when the user terminal 200 receives the display information for the contents display area from the server 100 and the processor 210 of the user terminal 200 generates at least one area of the screen based on the received display information.

In the present disclosure, a “unit area” may be one area of the contents display area output through the output unit 250 of the user terminal 200, and may output an image connected with a token registered to correspond to the unit area. Alternatively or additionally, the expression “a specific token is registered to correspond to a specific unit area” may refer to information indicating the location of the specific unit area together with (e.g., indicating an association with) identification information of the specific token (hereinafter, also referred to as “location information”) is stored or recorded in any storage space (e.g., memory 130 of server 100). The location information of the unit area registered to correspond to the specific token may be information indicating a location in the contents display area where an image connected with the corresponding token is displayed through the user terminal 200. One or more unit areas that may be registered to correspond to the specific token may have unique location information within the contents display area. Hereinafter, for convenience of description, “location information of a unit area registered to correspond to a specific token” may be briefly referred to as “specific token location information” or “location information of the specific token.” A method in which the server 100 registers a token is described in detail below.

If data or information is stored and managed by a related server using a centralized database according to a related database management scheme, a storage space burden on the related server may be increased and the data and/or information may possibly be leaked or damaged by hacking or attacking the server. Further, since a related server may be managed by a single subject, there is a possibility that such data or information may be changed by the subject, and thus the reliability of the information may be lowered. On the other hand, according to the disclosure of the present specification, when the server 100 manages the token using the blockchain technology, since token-related information is managed by the blockchain network 300, security is enhanced, the storage space burden on the server 100 is alleviated, and information reliability may be increased. As a result, improvements in database-related technology may be achieved.

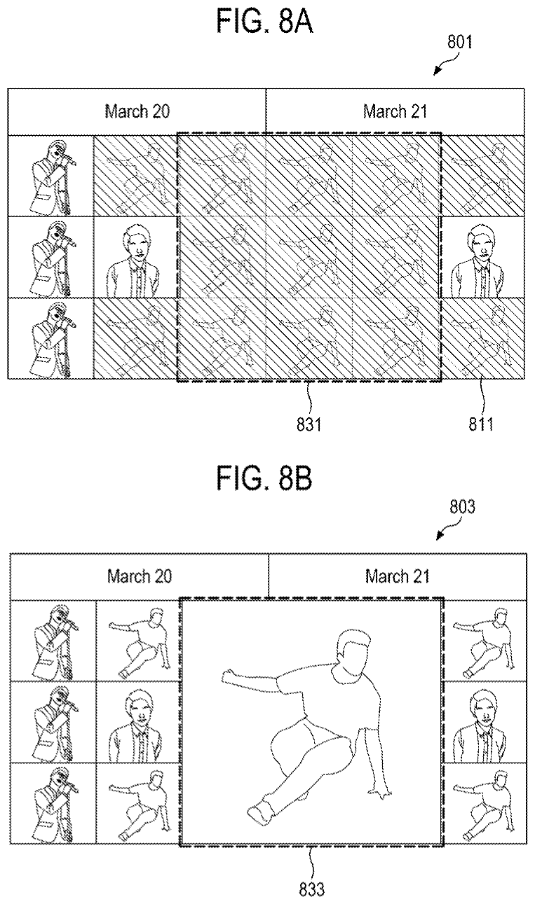

FIG. 6 is an exemplary view showing a contents display area 600 according to one embodiment of the present specification. The contents display area 600 may be expressed in the form of a two-dimensional array within at least one area of a screen output through the output unit 250 of the user terminal 200. The contents display area 600 may include at least one unit area. In the embodiment regarding the contents display area 600 of FIG. 6, the location information of a token registered to correspond to each unit area may include information indicating coordinates of the corresponding unit area on the contents display area 600 (hereinafter, also referred to as “coordinate information”). The coordinate information may be an ordered pair in the form of (x, y), or a number that follows a specific way of determining the order. For example, when the contents display area is displayed in the form of a two-dimensional array of a size of N×M (where N and M are integers greater than 0), the location information corresponding to each token may include coordinate information in the form of “(n, m)” (where n is an integer between 1 and N and m is an integer between 1 and M) or coordinate information in the form of “#k” (where k is an integer between 1 and N×M). In some embodiments, “k” in the coordinate information in the form of “#k” may be a number uniquely assigned to each of the unit areas included in the contents display area 600. In one embodiment, the coordinate information in the form of “(n, m)” may be converted into the coordinate information in the form of “#k” based on a formula such as “k=n+(m−1)×N.” For example, when the contents display area 600 displays a plurality of unit areas in the form of a two-dimensional array having a size of 20×20, the location information of a token registered to correspond to a first unit area 631 of the contents display area 600 may be expressed as, for example, (14, 7) or “#134.” For another example, the location information of a token registered to correspond to a second unit area 632 of the contents display area 600 may be expressed as, for example, (13, 14) or “#273.”

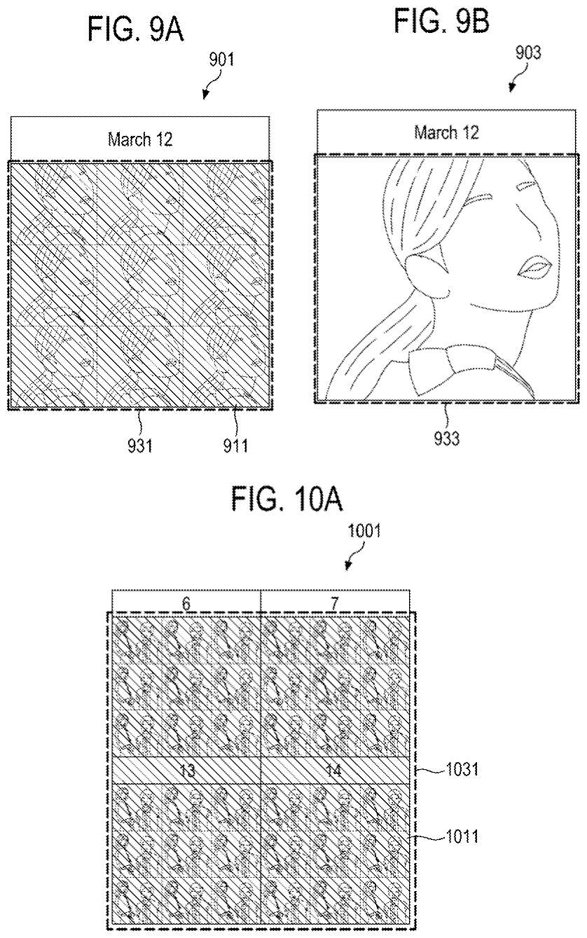

FIG. 7 is an exemplary view showing a contents display area 700 according to another embodiment of the present disclosure. The contents display area 700 may be expressed in the form of a calendar within at least one area of a screen output through the output unit 250 of the user terminal 200. The contents display area 700 may include one or more daily areas respectively corresponding to one or more dates.

In one embodiment in which the contents display area is expressed in the form of a calendar, the location information of a specific unit area may include information indicating a daily area to which the corresponding unit area belongs. The information indicating the daily area may be, for example, a date corresponding to the corresponding daily area. For example, a first daily area 710 of the contents display area 700 may include a first unit area 711, and the first daily area 710 may correspond to “Feb. 27, 2022.” In this case, the location information of the first unit area 711 may include “Feb. 27, 2022” as information indicating the first daily area 710. For another example, a second daily area 730 of the contents display area 700 may include a second unit area 731, and the second daily area 730 may correspond to “Mar. 18, 2022.” In this case, the location information of the second unit area 731 may include “Mar. 18, 2022” as information indicating the second daily area 730. Alternatively or additionally, when the daily area includes two or more unit areas, the location information of a specific unit area may further include coordinate information that the corresponding unit area has within the daily area. For example, the first daily area 710 of the contents display area 700 may include the first unit area 711 and a second unit area 713. In such an example, the first daily area 710 may express a plurality of unit areas in the form of a 3×3 array. In this case, since the first unit area 711 is located in the first row and the first column on the first daily area 710, it may further include coordinate information expressed as “(1,1)” or “#1.” In addition, since the second unit area 713 is located in the second row and the third column, it may further include coordinate information expressed as “(2,3)” or “#6.” That is, the location information of the first unit area 711 may be expressed as “Feb. 27, 2022 (1,1)” or “Feb. 27, 2022 #1.” In addition, the location information of the second unit area 713 may be expressed as “Feb. 27, 2022 (2,3)” or “Feb. 27, 2022 #6.”

In various embodiments according to the present disclosure, based on the token information and the location information, the processor 110 of server 100 may generate the display information according to whether or not unit areas adjacent to each other among a plurality of unit areas satisfy a preset merging condition.

In the present disclosure, the “unit areas adjacent to each other” may refer to a plurality of two or more unit areas having a vertically or horizontally continuous positional relationship with at least one of the remaining unit areas except for an arbitrary one unit area selected within a unit area plurality including two or more unit areas output from a contents display area. For example, the first unit area 711 and the second unit area 713 may not be unit areas adjacent to each other. Alternatively or additionally, a third unit area 751 and a fourth unit area 753 may correspond to unit areas adjacent to each other. On the other hand, the third unit area 751 and a fifth unit area 755, or the fourth unit area 753 and a sixth unit area 757 may correspond to unit areas adjacent to each other, respectively. That is, even if an area in which a date is displayed exists between two unit areas in the contents display area in the form of a calendar, it may be determined that the two unit areas have a continuous positional relationship. Accordingly, the third unit area 751, the fourth unit area 753, the fifth unit area 755, and the sixth unit area 757 may correspond to adjacent unit areas.

The “preset merging condition” according to the present disclosure may be, for example, a condition determined based on token information registered to correspond to adjacent unit areas.

According to a determination that the adjacent unit areas satisfy the preset merging condition, the processor 110 may generate information indicating that a specific image is displayed in a specific area among areas occupied by the adjacent unit areas within the contents display area (hereinafter, referred to as “second information”) and may generate display information including the generated second information.

The processor 110 may determine whether or not the adjacent unit areas satisfy the preset merging condition at a specific time, and may generate the second information indicating that the specific image is displayed in the specific area among the areas occupied by the adjacent unit areas within the contents display area. In this case, the specific time may be, for example, a time when a preset time (e.g., 1 second, 1 minute, etc.) periodically elapses, or a time when a token is registered in at least one unit area included in the contents display area.

The specific area in which the specific image is displayed in the contents display area by the second information generated by the processor 110 may be, for example, a rectangular arrangement area equal to or greater than a predetermined size or a rectangular arrangement area having the largest size among the areas occupied by the adjacent unit areas in the contents display area. The rectangular arrangement area may be an arrangement area having a rectangular shape, such as a rectangle having a different width and height, or a square having the same width and height. For example, the rectangular arrangement area may be a square array having the form of an N×N array (where N is a positive integer greater than 0) or a rectangular array having the form of an N×M array (where N and M are different positive integers greater than 0). The size of a rectangular arrangement area may be defined based on the number of unit areas included in the rectangular arrangement area. For example, when a predetermined size is set as the sum of the sizes of 8 unit areas, if a specific rectangular arrangement area includes 9 unit areas, the corresponding rectangular arrangement area may be determined to be a rectangular arrangement area equal to or greater than the predetermined size.

To determine whether the rectangular arrangement area is equal to or greater than the predetermined size or the rectangular arrangement area having the largest size among the areas occupied by the adjacent unit areas, the processor 110 may check whether at least two adjacent unit areas satisfy the preset merging condition. For example, the processor 110 may check whether a specific unit area satisfies the preset merging condition together with other unit areas adjacent to the left, right, upper, or lower side of the specific unit area. In one embodiment, if the specific unit area does not satisfy the preset merging condition with unit areas in all directions adjacent to the specific unit area, the processor 110 may stop the operation of checking whether the merging condition is satisfied or may check whether the merging condition is satisfied for other unit areas. In another optional or additional embodiment, if the specific unit area satisfies the preset merging condition with a unit area in one direction (e.g., the right side) adjacent to the specific unit area, the processor 110 may check whether another unit area located in the one direction (e.g., the right side) satisfies the preset merging condition with the specific unit area. Alternatively or additionally, the processor 110 may check whether another unit area located in a direction (e.g., the lower side) orthogonal to the one direction (e.g., the right side) satisfies the preset merging condition with the specific unit area. The processor 110 may determine the rectangular arrangement area equal to or greater than the predetermined size or the rectangular arrangement area having the largest size among the areas occupied by the adjacent unit areas by repeating (e.g., looping) the above-described method.

In one embodiment in which the processor 110 determines the rectangular arrangement area equal to or greater than the predetermined size or the rectangular arrangement area having the largest size among the areas occupied by the adjacent unit areas according to the present disclosure, the processor 110 may sequentially check at least one unit area in the downward direction of the contents display area from one unit area located at the uppermost portion of the contents display area. In this case, the processor 110 may check whether the specific unit area satisfies the preset merging condition together with other unit areas adjacent to the left, right, or lower side of the specific unit area. That is, by sequentially checking the unit areas from the top to the bottom of the contents display area, the processor 110 may omit checking whether the merging condition is satisfied for the unit area located in the upper direction of the specific unit area, and may quickly determine the rectangular arrangement area equal to or greater than the predetermined size or the rectangular arrangement area having the largest size among the areas occupied by the adjacent unit areas.

When a specific image is displayed in a specific area among areas occupied by adjacent unit areas in the contents display area by the second information generated by the processor 110, the type of the displayed image may be determined in various ways. For example, the processor 110 may enlarge the same image of tokens associated with the adjacent unit areas, and may display the enlarged image in the specific area. For example, the processor 110 may compare the number of adjacent unit areas that satisfy the preset merging condition with a threshold number (e.g., nine), and when the number of adjacent unit areas is equal to or greater than the threshold number, the processor 110 may display a separately set image in the specific area. For another example, when the adjacent unit areas satisfying the preset merging condition are associated with a specific date, the processor 110 may display an image set separately for the specific date on the specific area.

In one embodiment regarding the preset merging condition according to the present disclosure, the preset merging condition may be a condition satisfied when tokens registered to respectively correspond to adjacent unit areas are associated with the same image. In the case of determining that the preset merging condition is satisfied, the processor 110 may generate the second information indicating (or instructing) to display the image of the tokens registered in the entire rectangular arrangement area having the largest size among the areas occupied by the adjacent unit areas in the contents display area, and may generate the display information including the generated second information.

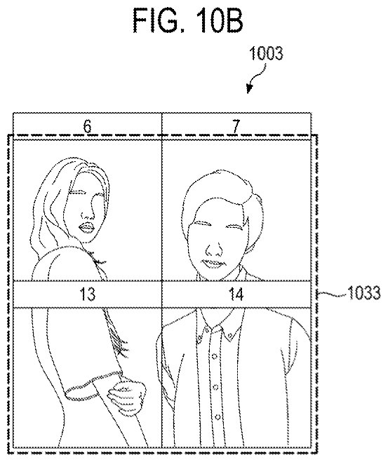

FIGS. 8A and 8B are exemplary views showing a contents display area output from the user terminal 200 based on the display information generated by the server 100 when the preset merging condition is satisfied according to one embodiment of the present disclosure.

A contents display area 801 of FIG. 8A conceptually shows a case where adjacent unit areas satisfy the preset merging condition. For example, a plurality of unit areas included in a first area 811 may correspond to the adjacent unit areas and may be associated with the same image. In this case, the processor 110 may determine that the plurality of unit areas included in the first area 811 satisfy the preset merging condition. Accordingly, the processor 110 may generate the second information indicating to display the image associated equally with tokens registered in a rectangular arrangement area 831 having the largest size in the first area 811 occupied by the adjacent unit areas that satisfy the preset merging condition, and may generate the display information including the generated second information.

A contents display area 803 of FIG. 8B may be one area of a screen output from the output unit 250 of the user terminal 200. The contents display area 803 may be generated based on the display information including the second information generated by the processor 110. A rectangular arrangement area 833 of the contents display area 803 may be set to have the same range as the rectangular arrangement area 831 having the largest size in the first areas 811 occupied by the adjacent unit areas satisfying the preset merging condition in FIG. 8A. An image with which a plurality of corresponding unit areas are equally associated may be output to the rectangular arrangement area 833 of the contents display area 803.

Alternatively or additionally, when the user terminal 200 receives a user input regarding the rectangular arrangement area 833 as a user touches or clicks the rectangular arrangement area 833, the user terminal 200 may divide and display the rectangular arrangement area 833 into a plurality of unit areas as in the rectangular arrangement area 831 of the contents display area 801 of FIG. 8A.

In another optional or additional embodiment regarding the preset merging condition according to the present disclosure, the preset merging condition may be a condition satisfied when tokens registered to respectively correspond to adjacent unit areas are associated with the same image and the adjacent unit areas occupy the whole specific daily area. When determining that this preset merging condition is satisfied, the processor 110 may generate the second information indicating to display the same image of the tokens in the whole specific daily area occupied by the adjacent unit areas in the contents display area, and may generate the display information including the generated second information.

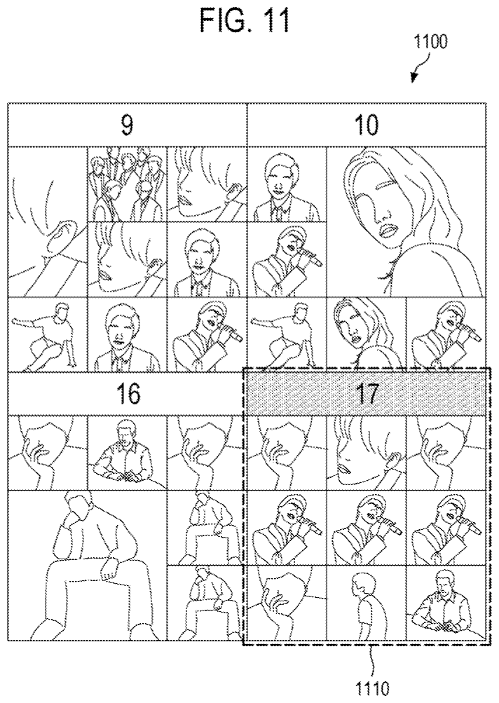

FIGS. 9A and 9B are exemplary views showing a contents display area output from the user terminal 200 based on the display information generated by the server 100 when the preset merging condition is satisfied according to another embodiment of the present disclosure.

A contents display area 901 of FIG. 9A conceptually shows a case where adjacent unit areas satisfy the preset merging condition. For example, a plurality of unit areas included in a second area 911 may correspond to the adjacent unit areas and be associated with the same image, and may be unit areas occupying the whole of a specific daily area (e.g., a daily area on Mar. 12, 2022). In this case, the processor 110 may determine that the plurality of unit areas included in the second area 911 satisfy the preset merging condition. Accordingly, the processor 110 may generate the second information indicating to display the image associated equally with tokens registered in the whole daily area 931 occupied by the adjacent unit areas that satisfy the preset merging condition, and may generate the display information including the generated second information.

A contents display area 903 of FIG. 9B may be one area of a screen output from the output unit 250 of the user terminal 200. The contents display area 803 may be generated based on the display information including the second information generated by the processor 110. A daily area 933 of the contents display area 903 may be set to have the same range as the daily area 931 occupied by the adjacent unit areas satisfying the preset merging condition in FIG. 9A. An image with which a plurality of corresponding unit areas are equally associated may be output to the daily area 933 of the contents display area 903.

Alternatively or additionally, when the user terminal 200 receives a user input regarding the daily area 933 as a user touches or clicks the daily area 933, the user terminal 200 may divide and display the daily area 933 into a plurality of unit areas as in the daily area 931 of the contents display area 901 of FIG. 9A.

In another optional or additional embodiment regarding the preset merging condition according to the present disclosure, the preset merging condition may be a condition satisfied when tokens registered to respectively correspond to adjacent unit areas are associated with the same image and the adjacent unit areas occupy all of a plurality of adjacent daily areas. When determining that this preset merging condition is satisfied, the processor 110 may generate the second information indicating to display the same image of the tokens in the whole area occupied by the adjacent unit areas in the contents display area, and may generate the display information including the generated second information.

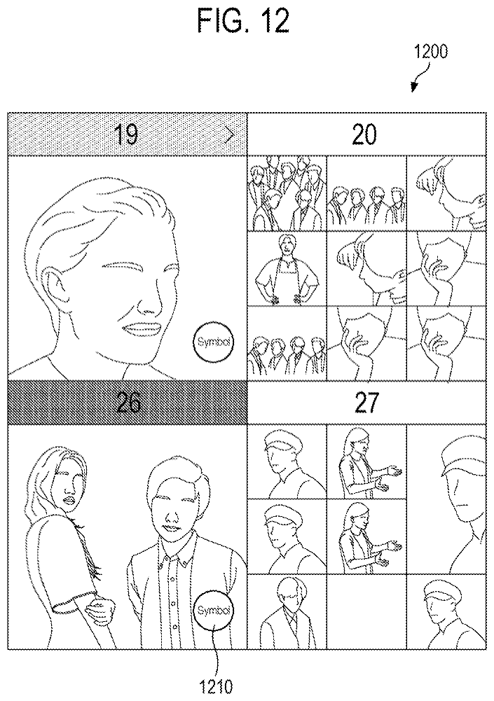

FIGS. 10A and 10B are exemplary views showing a contents display area output from the user terminal 200 based on the display information generated by the server 100 when the preset merging condition is satisfied according to another embodiment of the present disclosure.

A contents display area 1001 of FIG. 10A conceptually shows a case where adjacent unit areas satisfy the preset merging condition. For example, a plurality of unit areas included in a third area 1011 may correspond to the adjacent unit areas and be associated with the same image, and may be unit areas occupying the whole of a plurality of daily areas (e.g., a daily area on Mar. 6, 2022, a daily area on Mar. 7, 2022, a daily area on Mar. 13, 2022, and a daily area on Mar. 14, 2022). In this case, the processor 110 may determine that the plurality of unit areas included in the third area 1011 satisfy the preset merging condition. Accordingly, the processor 110 may generate the second information indicating to display the image associated equally with tokens registered in the whole area 1031 occupied by the adjacent unit areas that satisfy the preset merging condition, and may generate the display information including the generated second information.

A contents display area 1003 of FIG. 10B may be one area of a screen output from the output unit 250 of the user terminal 200. The contents display area 1003 may be generated based on the display information including the second information generated by the processor 110. A specific area 1033 of the contents display area 1003 may be set to have the same range as the specific area 1031 occupied by the adjacent unit areas satisfying the preset merging condition in FIG. 10A. An image with which a plurality of corresponding unit areas are equally associated may be output to the specific area 1033 of the contents display area 1003.

Alternatively or additionally, when the user terminal 200 receives a user input regarding the specific area 1033 as a user touches or clicks the specific area 1033 on the contents display area 1003, the user terminal 200 may divide and display the specific area 1033 into a plurality of unit areas as in the specific area 1031 of the contents display area 1001 of FIG. 10A.

As described above, in the content display method according to the present disclosure, a determination may be made as to whether or not the adjacent unit areas among the plurality of unit areas displayed in the contents display area satisfy the preset merging condition, and provide various screens output through the output unit 250 of the user terminal 200 depending on whether the preset merging condition is satisfied or not.

In various embodiments according to the present disclosure, the display information may be generated based on token information of tokens registered to respectively correspond to a plurality of unit areas belonging to one daily area in the contents display area. For example, the processor 110 may determine, based on the token information and location information, whether the ratio of unit areas associated with the same specific object to the unit areas belonging to one daily area in the contents display area is equal to or greater than a threshold ratio. The “unit areas associated with a specific object” may mean “unit areas in which tokens associated with the specific object are registered.” For example, it may be assumed that the number of unit areas included in the first daily area in the contents display area is nine, tokens are registered in all of the nine unit areas, and the threshold ratio is 70%. Under the above assumption, if the number of tokens associated with a singer “A” among a plurality of tokens registered in the nine unit areas included in the first daily area is nine, since the ratio of the unit areas associated with the singer “A” in the first daily area is 100%, the processor 110 may determine that the ratio of the unit areas associated with the singer “A” in the first daily area is equal to or greater than the threshold ratio. Alternatively or additionally, if the number of tokens associated with the singer “A” among the plurality of tokens registered in the nine unit areas included in the first daily area is six, since the ratio of the unit areas associated with the singer “A” in the first daily area is about 66.7%, the processor 110 may determine that the ratio of the unit areas associated with the singer “A” in the first daily area is not equal to or greater than the threshold ratio.

In one embodiment, when the processor 110 determines that the ratio of the unit areas associated with the same specific object belonging to one daily area in the contents display area is equal to or greater than the threshold ratio, the processor 110 may generate information indicating to display a color corresponding to the specific object (hereinafter, also referred to as “third information”) in the daily area, and may generate the display information including the generated third information.

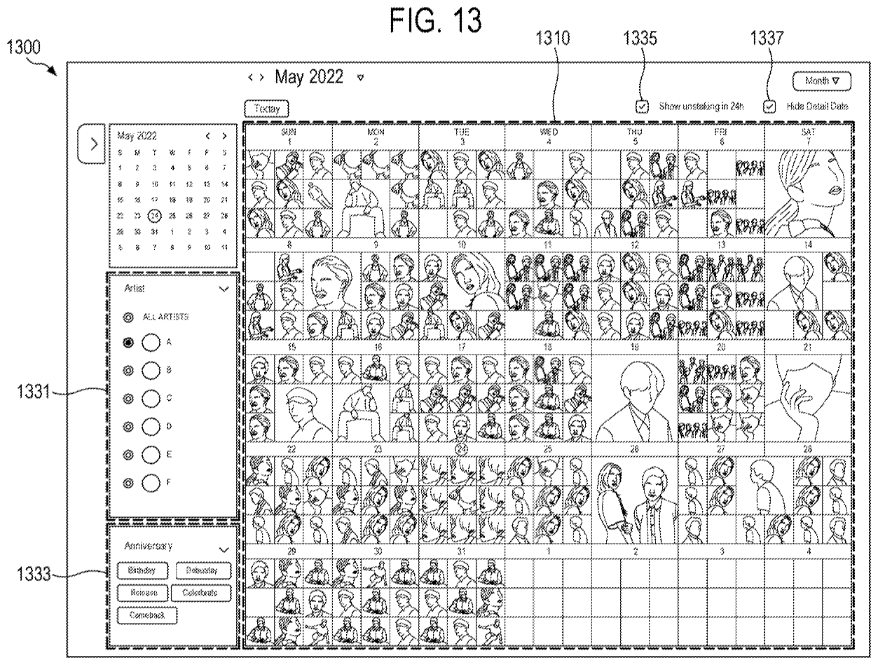

FIG. 11 is an exemplary view showing a contents display area in which a color corresponding to a specific object is displayed in a specific daily area according to one embodiment of the present disclosure. The contents display area 1100 of FIG. 11 is one area of a screen output through the output unit 250 of the user terminal 200, and may be generated by the processor 210 of the user terminal 200 based on the display information including the third information. For example, assuming that the ratio of the unit areas associated with the same specific object to the unit areas belonging to a daily area 1110 corresponding to 17th day included in the contents display area 1100 is equal to or greater than the threshold ratio, the daily area 1110 may be displayed in a color corresponding to the same specific object.

In one embodiment, when the processor 110 determines that the ratio of the unit areas associated with the same specific object belonging to one daily area in the contents display area is equal to or greater than the threshold ratio, the processor 110 may generate information indicating to display a symbol image corresponding to the specific object (hereinafter, also referred to as “fourth information”) in the daily area, and may generate the display information including the generated fourth information.

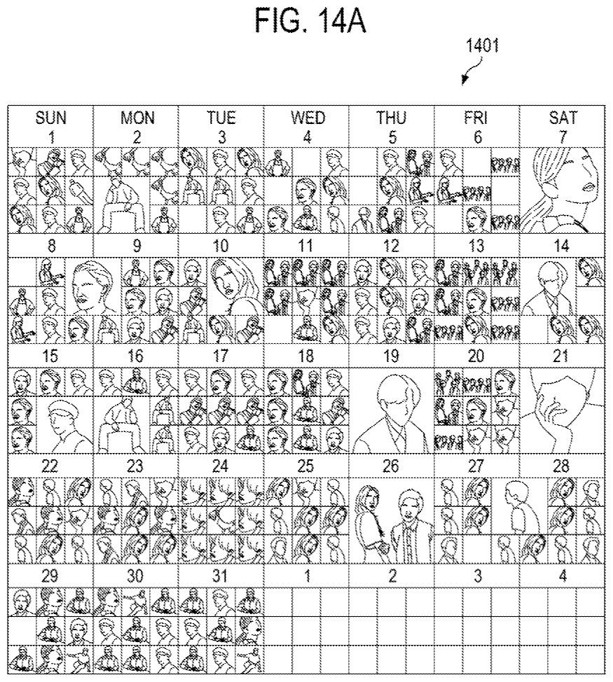

FIG. 12 is an exemplary view showing a contents display area in which a symbol image corresponding to a specific object is displayed in a specific daily area according to one embodiment of the present disclosure. The contents display area 1200 of FIG. 12 is one area of a screen output through the output unit 250 of the user terminal 200 and may be generated by the processor 210 of the user terminal 200 based on the display information including the fourth information. For example, assuming that the ratio of the unit areas associated with the same specific object to the unit areas belonging to a daily area corresponding to 26th day included in the contents display area 1200 is equal to or greater than the threshold ratio, a symbol image corresponding to the same specific object may be displayed in a symbol image display area 1210 included in the daily area corresponding to 26th day.

In various embodiments according to the present disclosure, at least one button for manipulating the contents display area may be included in the screen output through the output unit 250 of the user terminal 200. For example, when the user terminal 200 receives a user input for selecting a button as a user touches or clicks at least one button included in the contents display area, the user terminal 200 may transmit the user input for selecting a specific button to the server 100. The server 100 receiving the user input for selecting the specific button may generate the display information to be output to the contents display area as the corresponding button is selected, and may transmit it to the user terminal 200. The button included in the contents display area may include, for example, at least one of a filtering button related to a specific object, a filtering button related to a specific anniversary, a filtering button related to a token whose lockup is released within a certain period, and a date display omission button.

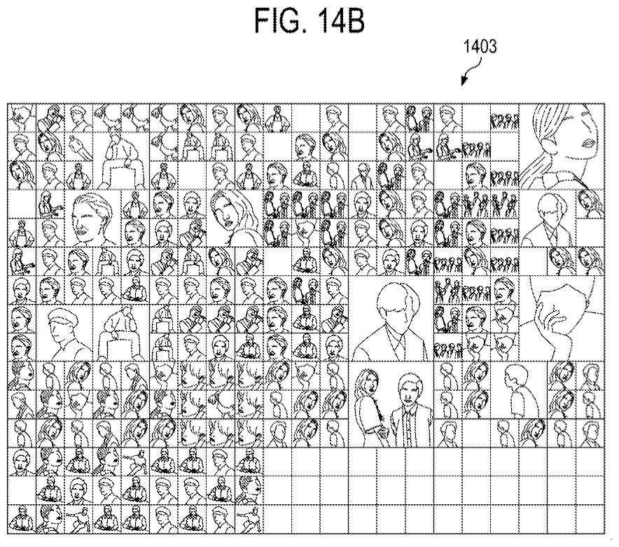

FIG. 13 is an exemplary view showing a first screen 1300 that is output through the output unit 250 of the user terminal 200 and includes at least one filtering button according to one embodiment of the present disclosure.

In one embodiment, the first screen 1300 may include a filtering button area 1331 related to a specific object. The filtering button area 1331 related to the specific object may include a filtering button corresponding to at least one specific object. For example, when a user selects a filtering button corresponding to a specific object “A” in the filtering button area 1331 related to the specific object, only a unit area associated with the specific object “A” in the contents display area 1310 included in the first screen 1300 may be displayed brightly (e.g., highlighted) and the other unit areas may be displayed darkly (e.g., not highlighted).

In one embodiment, the first screen 1300 may include a filtering button area 1333 related to a specific anniversary. The filtering button area 1333 related to the specific anniversary may include a filtering button corresponding to at least one specific anniversary. The filtering button area 1333 related to the specific anniversary may include filtering buttons corresponding to anniversaries such as a birthday, an entertainer's debut date, an entertainer's comeback date, and a singer's album release date. When a user selects a filtering button corresponding to the birthday in the filtering button area 1333 related to the specific anniversary, only unit areas of tokens registered to correspond to the birthday of a specific object associated with each token among tokens registered to correspond to a plurality of unit areas in the contents display area 1310 included in the first screen 1300 may be displayed brightly and the other unit areas may be displayed darkly.

In one embodiment, the first screen 1300 may include a filtering button 1335 related to a token whose lockup is released within a certain period. When the user selects the filtering button 1335 related to the token whose lockup is released, only unit areas of tokens whose lockup is scheduled to be released within the specific period among the tokens registered to correspond to the plurality of unit areas in the contents display area 1310 included in the first screen 1300 may be displayed brightly and the other unit areas may be displayed darkly. An embodiment related to lockup of a token registered to correspond to a unit area will be described in detail below.

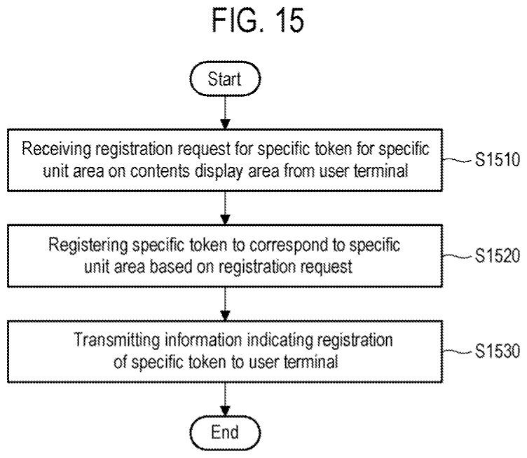

In one embodiment, the first screen 1300 may include a date display omission button 1337. When the user selects the date display omission button 1337, date display located at the top of each daily area in the contents display area 1310 included in the first screen 1300 may be omitted. Hereinafter, a contents display area in which the date display is omitted will be described with reference to FIGS. 14A and 14B.

FIGS. 14A and 14B are views exemplarily showing a contents display area in which a date display is included or omitted. In FIG. 14A, in a contents display area 1401 including the date display, a date may be displayed at the top of each daily area. On the other hand, in FIG. 14B, in a contents display area 1403 in which the date display is omitted, a portion on which a date is displayed may be omitted and a plurality of adjacent daily areas may be expressed so as to be in contact with each other. In one embodiment according to the present disclosure, when the date display omission button 1337 on the first screen 1300 of FIG. 13 is activated, the contents display area 1310 of the first screen 1300 may be expressed by omitting the date display similarly to the contents display area 1403 in which the date display is omitted.

As described above, the server 100 may generate the display information for the contents display area based on the token information of the token registered to correspond to each unit area, and transmit the display information to the user terminal 200, so that the user of the user terminal 200 may be provided with responsive contents according to an interaction. That is, as the user of the user terminal 200 registers his/her own token to correspond to a specific unit area within the contents display area, the contents display area may be expressed with an image of the token according to the user's own personality.

Hereinafter, a token registration method according to various embodiments disclosed in the present disclosure is described.

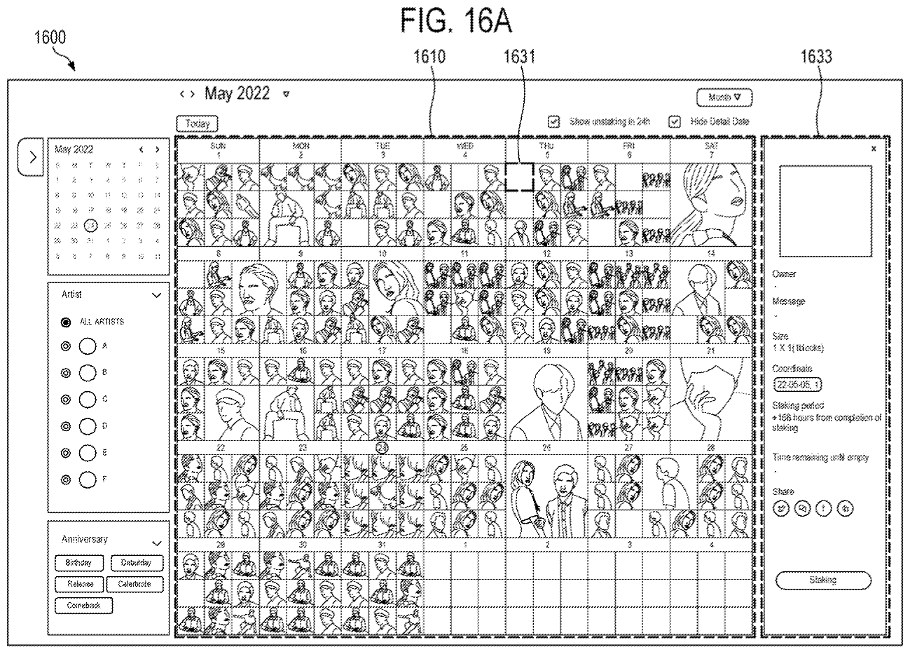

FIG. 15 is a flowchart of an operation of the server 100 that registers a token to correspond to a specific unit area according to one embodiment of the present disclosure.

The server 100 may receive a registration request for a specific token for a specific unit area in the contents display area from the user terminal 200 (S1510). The user terminal 200 may receive the registration request for the token for the specific unit area by outputting the contents display area through the output unit 250 and receiving from the user a series of user inputs including a user input such as touching or clicking the specific unit area in the contents display area. In the present disclosure, the “registration request for a specific token for a specific unit area” may be, for example, an hyper text transfer protocol (HTTP) request, and may include token identification information (e.g., token ID) identifying a specific token and location information indicating the location of a specific unit area.

In one embodiment, when the contents display area is expressed in the form of a two-dimensional array, the registration request for the specific token for the specific unit area may include the ID of the specific token and location information such as “(10, 10).” In another optional or additional embodiment, when the contents display area is expressed in the form of a calendar and a specific daily area includes one unit area, the registration request for the specific token for the specific unit area may include the ID of the specific token and location information such as “Feb. 27, 2022.” In another optional or additional embodiment, when the contents display area is expressed in the form of a calendar and a specific daily area includes two or more unit areas, the registration request for the specific token for the specific unit area included in the specific daily area may include the ID of the specific token and location information such as “Feb. 27, 2022 (2,3)” or “Feb. 27, 2022 #6.”

Alternatively or additionally, the registration request for the specific token for the specific unit area may further include memo information. The memo information may include, for example, a character string having a specific length, such as “New album success wish!”. In the present disclosure, the time when the server 100 receives the registration request transmitted from the user terminal 200 may be referred to as a “registration request reception time.”

The server 100 may register the specific token to correspond to the specific unit area based on the received registration request (S1520). In the present disclosure, the expression “a specific token is registered to correspond to a specific unit area” may refer to the server 100 associating a specific token with location information of the specific unit area and generating information indicating that the specific token is registered to correspond to the specific unit area (hereinafter, also referred to as “token-location registration information”). The token-location registration information may include, for example, at least one of a token ID of a token for which registration is requested, a registration request reception time, location information of a specific unit area, and memo information included in the registration request. For example, the token-location registration information may be expressed as {“token ID”: “0x123456”, “registration request reception time”: “2022-07-01 18:30:00”, “location information of specific unit area”: “Aug. 15, 2022, (3,3)”, “memo”: “My favorite!” }. Alternatively or additionally, the token-location registration information generated as a result of registering the specific token to correspond to the specific unit area may further include a “registration start time.” The “registration start time” may be the same time as the registration request reception time. The “registration start time” may be a time after the registration request reception time and may be set to at least one of a time when a token is registered to correspond to a specific unit area, a time when the token-location registration information is generated, and a time when the token-location registration information is recorded on one block on a blockchain.

The token-location registration information may be recorded in an arbitrary storage space. For example, the token-location registration information may be stored in the memory 130 of the server 100 or may be recorded on the blockchain. In one embodiment in which the token-location registration information is stored in the memory 130 of the server 100, the processor 110 may store the token-location registration information, which is generated based on the registration request, in the memory 130. For example, when the server 100 receives a registration request for registering a specific token (token “A”) to correspond to a specific unit area (Jan. 1, 2023, (3,2)), the processor 110 may store the token-location registration information including “Jan. 1, 2023, (3,2)” as the token ID of the token “A” and the location information of the unit area in the memory 130. In another optional or additional embodiment in which the token-location registration information is recorded on the blockchain, the processor 110 may transmit the token-location registration information, which is generated based on the registration request, to at least one blockchain node 310 of the blockchain network 300. As a result, the fact that the specific token was registered on a specific date may be recorded in one block on the blockchain. For example, when the server 100 receives the registration request for registering the specific token (token “A”) to correspond to the specific unit area (Jan. 1, 2023, (3,2)), the processor 110 may generate the token-location registration information including “Jan. 1, 2023, (3,2)” as the token ID of the token “A” and the location information of the unit area, and may transmit a transaction including the generated token-location registration information to at least one blockchain node 310 of the blockchain network 300. The blockchain network 300 may verify the received transaction and, when the verification is completed, may record the transaction including the token-location registration information in one block on the blockchain.

The server 100 may transmit information indicating registration of the specific token to the user terminal 200 (S1530). The information indicating the registration of the specific token may be approval information for the registration request when the registration of the specific token for the specific unit area is successful. If the registration of the specific token for the specific unit area is unsuccessful, the server 100 may transmit information indicating failure of registration of the first token to the user terminal 200. As described above, the server 100 may register a specific token to correspond to a specific date based on the received registration request and request a record in at least one block on the blockchain, which may result in preventing forgery or falsification of whether the specific token is registered on the specific date.

In one embodiment according to the present disclosure, a specific token registered to correspond to a specific unit area may be locked-up for a certain period from the registration start time. In the present disclosure, the expression “a token is locked-up for a specific period after being registered” may refer to deregistration of the token, transfer of ownership of the token, incineration of the token, etc. not being permitted (e.g., allowed) from the time when token registration is started until the elapse of a specific period. Hereinafter, a token locked-up for a specific period after being registered may be referred to as a “token in lock-up state” for convenience.

The lock-up state of the token may be released when a specific condition is satisfied. In one embodiment, the condition for releasing the lock-up state (hereinafter, also referred to as a “lock-up release condition”) may be satisfied when a certain period for releasing the lock-up has elapsed from the registration start time. For example, it may be assumed that the certain period for releasing the lock-up is 3 months and the token-date registration information of the first token registered to correspond to a specific date is {“token ID”: “0x123456”, “registration request reception time”: “2022-07-01 18:30:00”, “location information of specific unit area”: “2022-08-15, (3,3)”, “memo”: “My favorite!”, “registration start time”: “2022-07-01 18:31:00” }. At this case, the first token may remain in the locked-up state until Oct. 1, 2022, 6:31:00 PM, which is 3 months from the registration start time (Jul. 1, 2022, 6:31:00 PM), and release of the lock-up state of the first token may not be possible until the lock-up release period has elapsed. That is, when the server 100 receives, from the user terminal 200, at least one of a deregistration request for the first token, a request for transferring the ownership of the first token, and a request for incinerating the first token before 6:31:00 PM on Oct. 1, 2022, the processor 110 may reject the processing of the received request and transmit rejection information to the user terminal 200.

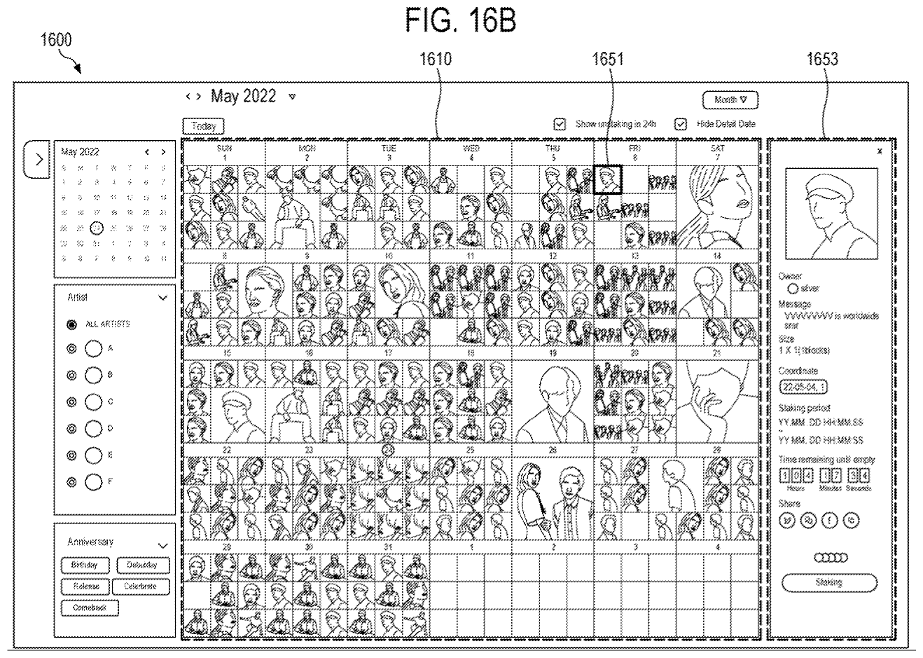

FIG. 16A is an exemplary view showing a second screen 1600 output through the output unit 250 of the user terminal 200 in the process of registering a token according to one embodiment of the present disclosure. A user may select a unit area 1631 in which a token is not registered in a contents display area 1610 of the second screen 1600 output through the output unit 250 of the user terminal 200. In this case, a detailed information area 1633 of the token for which registration of the selected unit area 1631 is desired may be displayed on at least a portion of the second screen 1600. At least one of an image connected with the token, ID of the token, location information of the unit area 1631 to be registered to correspond to the token, the owner of the token, and memo information included in the registration request may be expressed in the detailed information area 1633 of the token for which registration is desired. Alternatively or additionally, a registration request button may be included in the detailed information area 1633 of the token for which registration is desired. The user may request the server 100 to register a specific token for a specific unit area by clicking or touching the registration request button.

FIG. 16B is an exemplary view showing a second screen 1600 output through the output unit 250 of the user terminal 200 in the process of registering a token according to another embodiment of the present disclosure. A user may select a unit area 1651 in which a token is registered in a contents display area 1610 of the second screen 1600 output through the output unit 250 of the user terminal 200. In this case, a detailed information area 1653 of the token registered to correspond to the selected unit area 1651 may be displayed on at least a portion of the second screen 1600. At least one of an image connected with the token, an ID of the token, location information of the unit area 1651 registered to correspond to the token, the owner of the token, memo information included in the registration request, and a lock-up period of the registered token may be expressed in the detailed information area 1653 of the registered token. Alternatively or additionally, the detailed information area 1653 of the registered token may include a notification button for lock-up release (hereinafter, also referred to as a “vacancy notification button”). The user may request the server 100 to transmit notification information on lock-up release of a specific token registered to correspond to a specific unit area by clicking or touching the notification button for lock-up release.

Alternatively or additionally, the server 100 may receive a “deregistration request” of a specific token registered to correspond to a specific unit area from the user terminal 200. The “deregistration request” may include a token ID identifying a specific token or location information of a unit area in which the token is registered. Based on the deregistration request, the server 100 may deregister the token registered to correspond to the specific unit area. The time when the server 100 receives the deregistration request transmitted from the user terminal 200 may be referred to as a “deregistration request reception time.”

In the present disclosure, the expression “a specific token registered to correspond to a specific unit area is deregistered” may refer to the token-location registration information stored in the memory 130 of the server 100 being deleted or information indicating that a specific unit area of a specific token is deregistered (hereinafter, also referred to as “token-location deregistration information”) being recorded in one block on the blockchain managed by the blockchain network 300. For example, when a deregistration request for the first token for a specific date is received from the server 100 in a state where the token-location registration information is stored in the memory 130 of the server 100, the processor 110 may delete, from the memory 130, the token-location registration information indicating that the first token is registered to correspond to a specific unit area. Alternatively or additionally, when a deregistration request for the first token for a specific unit area is received from the server 100 in a state where the token-location registration information is recorded on the blockchain, the processor 110 may transmit the token-location deregistration information to at least one blockchain node 310 of the blockchain network 300. The token-location deregistration information may include, for example, at least one of a token ID of a token for which deregistration is requested, a deregistration request reception time, and transaction information on the token-location registration information to be deregistered.

When there is a registration request for two or more different tokens for the same unit area in the contents display area, the server 100 according to the present disclosure may determine a token to be registered to correspond to the corresponding unit area in various ways.

In one embodiment, when there is a registration request for two or more different tokens for the same unit area, the server 100 may determine, on a first-come, first-served basis, a token to be registered to correspond to the corresponding unit area. For example, it may be assumed that after receiving a registration request for a first token for a first unit area in the contents display area from a first user terminal 200, the server 100 receives a registration request for a second token for the same first unit area from a second user terminal 200. In this case, the processor 110 may determine a token to be registered to correspond to the first unit area based on the time when each of the registration request for the first token and the registration request for the second token is received (e.g., the registration request reception time).

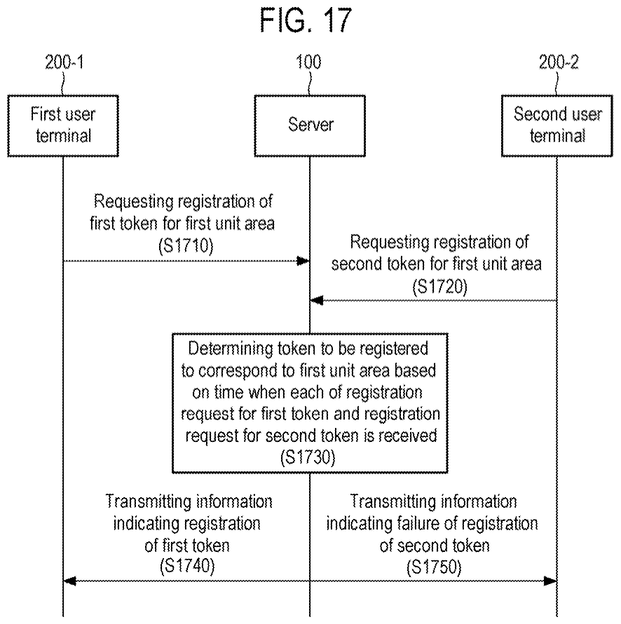

FIG. 17 is a flowchart of an operation of the server 100 that determines, on a first-come, first-served basis, a token to be registered to correspond to a specific unit area according to one embodiment of the present disclosure.

The server 100 may receive the registration request for the first token for the first unit area from the first user terminal 200-1 (S1710). Thereafter, the server 100 may receive the registration request for the second token for the first unit area from the second user terminal 200-2 (S1720). Steps S1710 and S1720 may be performed by the processor 110 in the same manner as step S1510 described above with reference to FIG. 15.

The server 100 may determine a token to be registered to correspond to the first unit area based on the time when each of the registration request for the first token and the registration request for the second token is received (S1730). For example, if the registration request reception time for the registration request for the first token is earlier than the registration request reception time for the registration request for the second token, the processor 110 may determine the first token to correspond to the first unit area. Alternatively or additionally, if the registration request reception time for the registration request for the first token is later than the registration request reception time for the registration request for the second token, the processor 110 may determine the second token to correspond to the first unit area. Referring to FIG. 17, for convenience of description, it is assumed that the registration request reception time for the registration request for the first token transmitted from the first user terminal 200-1 is earlier than the registration request reception time for the registration request for the second token transmitted from the second user terminal 200-2.

The server 100 may transmit information indicating registration of the first token to the first user terminal 200-1 (S1740). Alternatively or additionally, the server 100 may transmit information indicating failure of registration of the second token to the second user terminal 200-2 (S1750). The server 100 may first perform any one of steps S1740 and S1750 and/or perform both steps simultaneously.

In another optional or additional embodiment, when there is a registration request for two or more different tokens for the same unit area, the server 100 may determine, by a voting method, a token to be registered to correspond to the corresponding unit area.

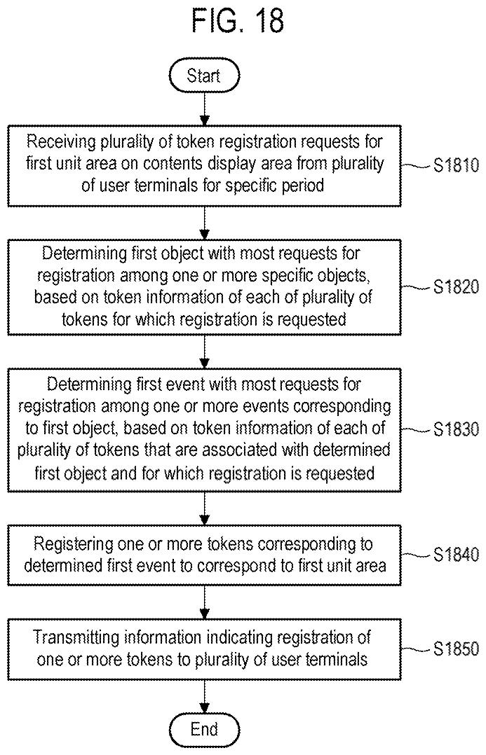

FIG. 18 is a flowchart of an operation of the server 100 that determines, by a voting method, a token to be registered to correspond to a specific unit area according to one embodiment of the present disclosure.

The server 100 may receive a plurality of token registration requests for a specific unit area (hereinafter, also referred to as a “first unit area”) in the contents display area from a plurality of user terminals 200 for a specific period (S1810). For example, the server 100 may receive a plurality of token registration requests for the first unit area from the respective plurality of user terminals 200 in the same manner as in S1510 of FIG. 15. The specific period during which the token registration requests may be received from the respective plurality of user terminals 200 may be set by an operator of the server 100 to, for example, 1 hour, 1 day, 1 week, etc.

Based on token information of each of the plurality of tokens for which registration is requested, the server 100 may determine a specific object with the most requests for registration (hereinafter, also referred to as a “first object”) among one or more specific objects (S1820). For example, it may be assumed that the plurality of tokens have five pieces of information exemplified as [{“token ID”: 1, “associated specific object”: “A”, “event ID”: 1, “issue number”: 1/1000}, {“token ID”: 2, “associated specific object”: “A”, “event ID”: 1, “issue number”: 2/1000}, {“token ID”: 3, “associated specific object”: “A”, “event ID”: 2, “issue number”: 100/200}, {“token ID”: 4, “associated specific object”: “B”, “event ID”: 3, “issue number”: 1/10}, {“token ID”: 5, “associated specific object”: “B”, “event ID”: 4, “issue number”: 15568/20000}]. In this case, tokens having token IDs of 1, 2, and 3, respectively, may be tokens associated with the specific object “A,” and tokens having token IDs of 4 and 5, respectively, may be tokens associated with the specific object “B.” That is, the number of times that registration is requested for the specific object “A” may be 3, the number of times that registration is requested for the specific object “B” may be 2, and accordingly, the specific object with the most requests for registration may be determined as “A.”

Based on the token information of each of the plurality of tokens that are associated with the determined first object and for which registration is requested, the server 100 may determine a specific event with the most requests for registration (hereinafter, also referred to as a “first event”) among one or more events corresponding to the first object (S1830). For example, the token information of each of the plurality of tokens that are associated with the first object determined in step S1820 and for which registration is requested may be expressed as [{“token ID”: 1, “associated specific object”: “A”, “event ID”: 1, “issue number”: 1/1000}, {“token ID”: 2, “associated specific object”: “A”, “event ID”: 1, “issue number”: 2/1000}, {“token ID”: 3, “associated specific object”: “A”, “event ID”: 2, “issue number”: 100/200}]. In this case, tokens having token IDs of 1 and 2, respectively, may be tokens that are associated with the specific object “A,” which is the determined first object, and correspond to an event having an event ID of 1, and a token having a token ID of 3 may be a token that is associated with the specific object “A,” which is the determined first object, and corresponds to an event having an event ID of 2. That is, the number of times that registration is requested for the event having the event ID of 1 may be 2, the number of times that registration is requested for the event having the event ID of 2 may be 1, and accordingly, the event with the most requests for registration may be determined as the event having the event ID of 1.

The server 100 may register one or more tokens corresponding to the determined first event to correspond to the first unit area (S1840). For example, the token information of each of the one or more tokens corresponding to the first event determined in step S1830 may be expressed as [{“token ID”: 1, “associated specific object”: “A”, “event ID”: 1, “issue number”: 1/1000}, {“token ID”: 2, “associated specific object”: “A”, “event ID”: 1, “issue number”: 2/1000}]. In this case, tokens having token IDs of 1 and 2 are the one or more tokens corresponding to the determined first event, and the processor 110 may register the corresponding tokens to correspond to the first unit area.

The server 100 may transmit information indicating registration of the one or more tokens to the plurality of user terminals 200 (S1850). Information indicating registration of a token may include, for example, an image of an event corresponding to one or more tokens. The server 100 may finally transmit an image of an event corresponding to one or more tokens registered to correspond to the first unit area to the plurality of user terminals 200 that have requested token registration for the first unit area.

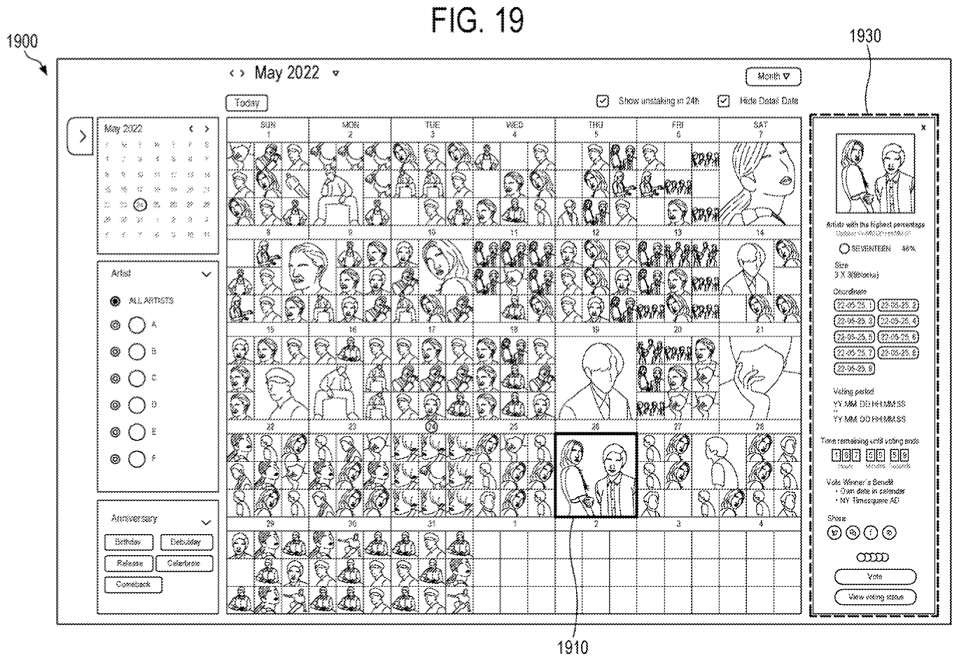

FIG. 19 is an exemplary view showing a third screen 1900 output through the output unit 250 of the user terminal 200 in the process of registering a token in a voting method according to one embodiment of the present disclosure. For example, a unit area 1910 in which a token is registered in a voting method in a contents display area of the third screen 1900 may be a unit area belonging to a daily area corresponding to May 25, 2022. A specific period during which a token registration request for the unit area 1910 may be received may be set to, for example, one week. A user may select the unit area 1910 in which the token is registered in a voting method in the contents display area of the third screen 1900 output through the output unit 250 of the user terminal 200. In this case, a voting information display area 1930 for the unit area 1910 in which the token is registered in the voting method may be displayed on at least one portion of the third screen 1900. At least one of an image of an event with the most requests for token registration, location information of the unit area 1910 in which the token is to be registered, and a specific period during which voting takes place may be displayed in the voting information display area 1930.

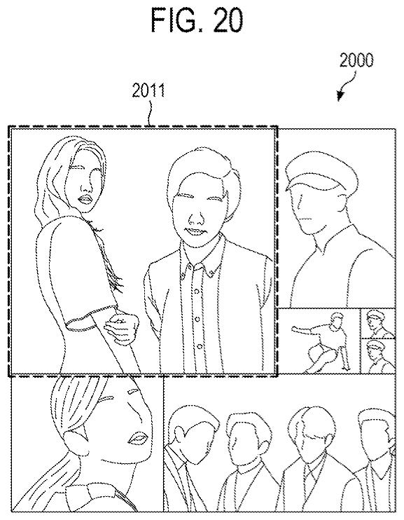

FIG. 20 is an exemplary view showing a voting status display area 2000 output through the output unit 250 of the user terminal 200 in the process of registering a token in a voting method according to one embodiment of the present disclosure. The voting status display area 2000 may visually express the number of tokens corresponding to the same event among a plurality of tokens for which registration is requested to correspond to a specific unit area. The voting status display area 2000 may display a larger image of a specific event as more registrations of tokens corresponding to the specific event are requested. For example, in the example of FIG. 20, an area 2011 of the first event included in the voting status display area 2000 may be displayed larger than areas of the other events. In this case, it may be understood that the number of tokens corresponding to the first event among the plurality of tokens for which registration is requested to correspond to the specific unit area is the largest. Alternatively or additionally, when a user touches, clicks, or hovers over an area of a specific event included in the voting status display area 2000, the area of the corresponding event may numerically display the current rate of votes earned.

As described above, when there is a registration request for two or more different tokens for the same unit area in the contents display area, the server 100 may determine a token to be registered in the unit area through a first-come, first-served method, a voting method, etc., thereby ensuring fair processing of token registration requested from a plurality of users and allowing a user to easily grasp a fandom of a specific object associated with each registered token.

The server 100 according to the present disclosure may determine whether to accept a registration request according to whether or not a token requested for registration satisfies a specific condition. Specifically, the processor 110 may determine whether or not a specific token requested for registration satisfies a preset registration condition. In the present disclosure, the “preset registration condition” refers to a token registration condition that may be set by the operator of the server 100, and may be a condition for determining whether or not the condition is satisfied based on the token information of each token.

In one embodiment, the preset registration condition may be a condition that is satisfied when date information of the unit area indicated by location information included in a registration request and date information about a specific object included in the token information of a token requested for registration are the same. For example, when the location information of a specific unit area included in the contents display area in the form of a calendar is “Mar. 11, 2022, (3,3)” and the date information for a specific object included in the token information of the token requested for registration for this specific unit area is “Mar. 11, 2022,” the processor 110 may determine that the corresponding token satisfies the preset registration condition.

In one embodiment, the preset registration condition may be a condition satisfied when the issue number of the token requested for registration is equal to a specific number. For example, it may be assumed that the specific number used as a criterion for determining whether or not the issue number is equal to the specific number is 1225. That is, if the token information of the token requested for registration is 1225 as the issue number such as {“token ID”: 1, “associated specific object”: “A”, “event ID”: 1, “issue number”: 1225/2000}, the processor 110 may determine that the corresponding token satisfies the preset registration condition.

In one embodiment according to the present disclosure, the processor 110 may transmit notification information for lock-up release of a registered specific token to the user terminal 200 at a specific time.

In one embodiment, the specific time may be a time at which the lock-up state of the registered specific token is released. For example, if the first token is locked-up until 6:31:00 PM on Oct. 1, 2022, the processor 110 may transmit notification information for lock-up release of the first token to the user terminal 200 at 6:31:00 PM on Oct. 1, 2022 when the lock-up of the first token is released. In this case, the notification information for lock-up release of the first token may include a character string indicating “the lock-up of the first token has been released.”

In another optional or additional embodiment, the specific time may be a time before the lock-up state of the registered specific token is released. Specifically, the specific time may be a time prior to a specific period (e.g., 1 hour, 1 day, 1 week, etc.) from the time when the lock-up state of the registered specific token is released. For example, if the first token is locked-up until 6:31:00 PM on Oct. 1, 2022, the processor 110 may transmit the notification information for lock-up release of the first token to the user terminal 200 at 6:31:00 PM on Sep. 30, 2022, which is one day before 6:31:00 PM on Oct. 1, 2022 when the lock-up of the first token is released. In this case, the notification information for lock-up release of the first token may include a character string indicating “the lock-up of the first token is scheduled to be released in 1 day.” The server 100 may set the specific time for transmitting the notification information for lock-up release of a specific token based on information received from the user terminal 200 requesting registration of the specific token.

In one embodiment according to the present disclosure, the processor 110 may transmit the notification information for lock-up release of the specific token to a user terminal different from the user terminal requesting registration of the specific token.

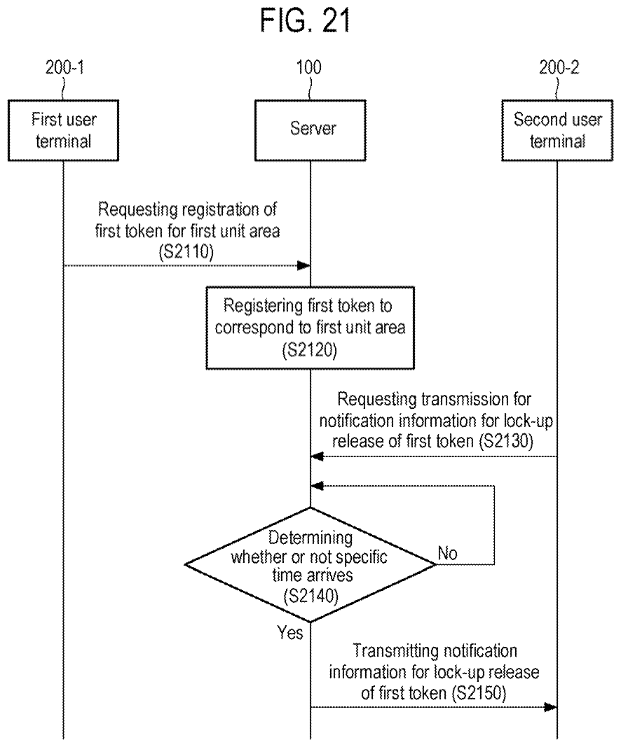

FIG. 21 is a flowchart showing an operation of the server 100 that communicates with a plurality of user terminals 200-1, 200-2, . . . , 200-n and transmits notification information for lock-up release of a specific token according to one embodiment of the present disclosure.

The server 100 may receive a registration request for the first token for the first unit area from the first user terminal 200-1 (S2110). The server 100 may register the first token to correspond to the first unit area according to the registration request (S2120). Steps S2110 and S2120 may be performed by the processor 110 in the same manner as steps S1510 and S1520 described above with reference to FIG. 15.

The server 100 may receive a transmission request for the notification information for lock-up release of the first token from the second user terminal 200-2 (S2130). For example, a user of the second user terminal 200-2 may request transmission of the notification information for lock-up release of the first token by inputting a user input of touching or clicking the first token registered to correspond to the first unit area in the contents display area output to the output unit of the user terminal. Accordingly, the server 100 may receive a transmission request for the notification information for lock-up release of the first token from the second user terminal 200-2. The transmission request for the notification information for lock-up release of the first token received from the second user terminal 200-2 may include, for example, information identifying the first token (e.g., the first token ID) or information indicating a location in the contents display area of the first unit area registered to correspond to the first token. Alternatively or additionally, the transmission request for the notification information for lock-up release of the first token received from the second user terminal 200-2 may further include information indicating a specific time. The information indicating the specific time is information indicating a notification time desired by the user of the second user terminal 200-2, and may indicate, for example, a time before a specific period (e.g., 1 hour, 1 day, 1 week, etc.) from the time when the lock-up state of the first token is released.

The server 100 may determine whether or not the specific time included in the transmission request for the notification information for lock-up release arrives (S2140). The server 100 may periodically determine whether or not the specific time arrives. For example, the server 100 may check every second, every minute, or every hour whether or not the specific time included in the transmission request for the notification information for lock-up release arrives. As a result of the determination in step S2140, when the specific time arrives, the server 100 may transmit the notification information for lock-up release of the first token to the second user terminal 200-2 (S2150).

According to the present disclosure as described above, the user of the second user terminal 200-2 may easily acquire the notification information for lock-up release of a specific token registered to correspond to a specific unit area by the user of the first user terminal 200-1 and accordingly may receive a vacancy notification for the contents display area.

In the sequence diagram or flowchart according to the present disclosure, steps of a method or algorithm are described in a sequential order, but the steps may be performed according to orders that may be arbitrarily combined, in addition to being performed sequentially. The sequence diagram or flowchart described herein does not exclude making changes or modifications to the method or algorithm and does not imply that any step is essential or desirable. In one embodiment, at least some of the steps may be performed in parallel, iteratively, or heuristically. In one embodiment, at least some of the steps may be omitted, or other steps may be added.

Various embodiments according to the present disclosure may be implemented as software on a machine-readable storage medium. The software may be software for implementing various embodiments of the present disclosure. The software may be inferred from the various embodiments of the present disclosure by programmers in the art to which the present disclosure pertains. For example, the software may be a program that includes machine-readable instructions (e.g., code or code segments). The machine is a device capable of operating according to an instruction called from a storage medium, and may be, for example, a computer. In one embodiment, the machine may be a computing device according to various embodiments of the present disclosure. In one embodiment, a processor of the machine may execute a called instruction to cause components of the machine to perform a function corresponding to the instruction. In one embodiment, the processor may be the processor 110 and 210 according to the embodiments of the present disclosure. The storage medium may refer to any type of recording medium that may be read by the machine and in which data is stored. Examples of the storage medium may include read-only memory (ROM), random-access memory (RAM), compact disc read-only memory (CD-ROM), magnetic tape, floppy disk, optical data storage device, and the like. In one embodiment, the storage medium may be the memory 130 and 230. In one embodiment, the storage medium may be implemented as a distributed form in a computer system or the like connected to a network. The software may be distributed, stored, and executed in a computer system or the like. The storage medium may be a non-transitory storage medium. The non-transitory storage medium refers to a tangible medium that exists regardless of whether data are stored semi-permanently or temporarily, and does not include signals that are propagated transitorily.

Although the technical ideas according to the present disclosure have been described with the above various embodiments, the technical ideas according to the present disclosure include various substitutions, modifications, and alterations that may be made within a range that be understood by a person having ordinary knowledge in the art to which the present disclosure pertains. It is also to be understood that such substitutions, modifications, and alterations may fall within the scope of the appended claims.

According to the present disclosure in at least one embodiment, a user of a user terminal may be provided with responsive contents according to an interaction with an operator of a server.

According to the present disclosure in at least one embodiment, a user may express a contents display area with an image of a token that the user owns, according to the user's own personality.

According to the present disclosure in at least one embodiment, fair processing of token registration requested from a plurality of users may be provided.

According to the present disclosure in at least one embodiment, a user may easily grasp a fandom of a specific object associated with each registered token.

According to the present disclosure in at least one embodiment, a user of one user terminal may easily acquire notification information for lock-up release of a specific token registered by a user of another user terminal and accordingly receive a vacancy notification for a contents display area.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. An electronic apparatus, comprising:
a communication interface configured to communicate with one or more nodes of a blockchain network and a first external device;
one or more memories configured to store one or more instructions; and
one or more processors configured to execute the one or more instructions to:
generate display information for a contents display area based on token information of tokens registered to respectively correspond to a plurality of unit areas included in the contents display area; and
transmit, via the communication interface, the display information to the first external device,
wherein the display information indicates at least one image to be displayed in the contents display area displayed on the first external device, and
wherein to transmit the display information to the first external device causes the first external device to display the display information in the contents display area on the first external device.

2. The electronic apparatus of claim 1, wherein the one or more processors are further configured to execute the one or more instructions to:
generate first information indicating images to be displayed in each of the plurality of unit areas based on the token information and location information indicating a location of each of the plurality of unit areas in the contents display area; and
generate the display information including the first information.

3. The electronic apparatus of claim 2, wherein
the contents display area comprises one or more daily areas respectively corresponding to one or more dates, and each of the one or more daily areas comprises one or more unit areas of the plurality of unit areas, and
the location information comprises information indicating a daily area to which each of the plurality of unit areas belongs.

4. The electronic apparatus of claim 2, wherein the location information comprises information indicating coordinate positioning information of each of the plurality of unit areas in the contents display area.

5. The electronic apparatus of claim 2, wherein the one or more processors are further configured to execute the one or more instructions to:
determine whether adjacent unit areas among the plurality of unit areas satisfy a preset merging condition, based on the token information and the location information;
based on a determination that the adjacent unit areas satisfy the preset merging condition, generate second information indicating that an image is to be displayed in an indicated unit area of the adjacent unit areas; and
generate the display information including the second information.

6. The electronic apparatus of claim 5, wherein the preset merging condition is satisfied when adjacent tokens registered to respectively correspond to the adjacent unit areas are associated with a same image.

7. The electronic apparatus of claim 6, wherein the indicated unit area comprises at least one of a first rectangular arrangement area having a first size equal to or greater than a predetermined size and a second rectangular arrangement area having a largest size among the adjacent unit areas.

8. The electronic apparatus of claim 5, wherein the preset merging condition is satisfied when adjacent tokens registered to respectively correspond to the adjacent unit areas are associated with a same image and the adjacent unit areas belong to a same daily area of the contents display area.

9. The electronic apparatus of claim 5, wherein the preset merging condition is satisfied when adjacent tokens registered to respectively correspond to the adjacent unit areas are associated with a same image and the adjacent unit areas belong to a plurality of adjacent daily areas of the contents display area.

10. The electronic apparatus of claim 3, wherein the one or more processors are further configured to execute the one or more instructions to:
determine whether a ratio of first unit areas associated with a same object to second unit areas belonging to one daily area in the contents display area is equal to or greater than a threshold ratio, based on the token information and the location information;
based on a determination that the ratio is equal to or greater than the threshold ratio, generate third information indicating that a color corresponding to the same object is to be displayed in the one daily area; and
generate the display information including the third information.

11. The electronic apparatus of claim 3, wherein the one or more processors are further configured to execute the one or more instructions to:
determine whether a ratio of first unit areas associated with a same object to second unit areas belonging to one daily area in the contents display area is equal to or greater than a threshold ratio, based on the token information and the location information;
based on a determination that the ratio is equal to or greater than the threshold ratio, generate fourth information indicating that a symbol image corresponding to the same object is to be displayed in the one daily area; and
generate the display information including the fourth information.

12. The electronic apparatus of claim 10, wherein the same object is selected from at least one of a person, a plurality of persons, and a company.

13. The electronic apparatus of claim 1, wherein the one or more processors are further configured to execute the one or more instructions to:
receive, via the communication interface from the first external device, a first registration request for a first token for a first unit area in the contents display area;
register the first token to correspond to the first unit area based on the first registration request; and
transmit, via the communication interface to the first external device, information indicating registration of the first token to the first unit area,
wherein the first registration request comprises location information indicating a location of the first unit area in the contents display area.

14. The electronic apparatus of claim 13, wherein
the communication interface is further configured to communicate with a plurality of external devices comprising the first external device, and
wherein the one or more processors are further configured to execute the one or more instructions to:
receive, via the communication interface from a second external device of the plurality of external devices, a second registration request for a second token for the first unit area; and
determine whether to select the first token or the second token to be registered to correspond to the first unit area based on a first timestamp indicating when the first registration request was received and a second timestamp indicating when the second registration request was received.

15. The electronic apparatus of claim 1, wherein
the communication interface is further configured to communicate with a plurality of external devices comprising the first external device, and
wherein the one or more processors are further configured to execute the one or more instructions to:
receive, via the communication interface from the plurality of external devices during a time period, a plurality of token registration requests for a first unit area in the contents display area;
determine a first object having a largest quantity of requests for registration among one or more objects, based on token information of each of the plurality of token registration requests;
determine a first event having a largest quantity of requests for registration among one or more events corresponding to the determined first object, based on token information of each of a plurality of token registration requests associated with the first object;
register one or more tokens corresponding to the determined first event to correspond to the first unit area; and
transmit, via the communication interface to the plurality of external devices, information indicating registration of the one or more tokens.

16. The electronic apparatus of claim 13, wherein the one or more processors are further configured to execute the one or more instructions to determine whether the first token satisfies a preset registration condition.

17. The electronic apparatus of claim 13, wherein the one or more processors are further configured to execute the one or more instructions to prevent changes to the registered first token during a lock-up time duration starting from a registration start time.

18. The electronic apparatus of claim 17, wherein the one or more processors are further configured to execute the one or more instructions to transmit, via the communication interface to the first external device at a first time point, notification information indicating a lock-up release of the first token at a specific time.

19. The electronic apparatus of claim 18, wherein the first time point corresponds to at least one of a time point at which a lock-up state of the registered first token is released and a time point before the lock-up state of the first token is released.

20. The electronic apparatus of claim 13, wherein
the communication interface is further configured to communicate with a plurality of external devices comprising the first external device,
wherein the one or more processors are further configured to execute the one or more instructions to:
receive, via the communication interface from a second external device of the plurality of external devices, a transmission request for notification information for lock-up release of the first token; and
transmit, via the communication interface to the second external device at a first time point, the notification information for the lock-up release of the first token,
wherein the transmission request for the notification information for the lock-up release comprises identifying information identifying the first token and the location information indicating the location of the first unit area registered to correspond to the first token in the contents display area.

21. A method performed by an electronic apparatus including one or more processors, comprising:
generating display information for a contents display area based on token information of tokens registered to respectively correspond to a plurality of unit areas included in the contents display area; and
transmitting the display information to an external device,
wherein the display information indicates at least one image to be displayed in the contents display area displayed on the external device, and
wherein the transmitting of the display information to the external device causes the external device to display the display information in the contents display area on the external device.

22. An electronic apparatus, comprising:
a communication interface configured to communicate with an external device;
one or more memories configured to store one or more instruction;
an output unit; and
one or more processors configured to execute the one or more instructions to:
receive display information from the external device; and
in response to receiving the display information, output, via the output unit, a contents display area including a plurality of unit areas based on the display information,
wherein the display information indicates at least one image to be displayed in the contents display area, and
wherein the display information has been generated for the contents display area based on token information of tokens registered to respectively correspond to the plurality of unit areas included in the contents display area.
